(19) United States
(12) Patent Application Publication
(10) Pub. No.: US 2019/0171990 A1
(43) Pub. Date: Jun. 6, 2019

(54) USING HISTORICAL PLANT-AVAILABLE WATER METRICS TO FORECAST CROP YIELD

(71) Applicant: South Country Equipment Ltd., Emerald Park (CA)

(72) Inventors: Ryan Hutchison, Emerald Park (CA); Kendall Gee, Emerald Park (CA)

(21) Appl. No.: 16/140,220

(22) Filed: Sep. 24, 2018

(30) Foreign Application Priority Data
Dec. 6, 2017 (CA) 2987761

(51) Int. Cl. G06Q 10/06; A01B 79/00; A01G 25/16; G06Q 50/02

(52) U.S. Cl. CPC G06Q 10/06375; G06Q 50/02; A01G 25/16; A01B 79/005

(57) ABSTRACT

A method of forecasting crop yield for a selected field crop planted at a field site based on the plant-available water within a growing season. A crop water use efficiency factor is established based on historical seasonal available water, which can be applied to current season precipitation and available water estimates. The method of estimating yield potential allows for accurate yield potential forecasting using only precipitation values and current plant-available moisture. Optimal embodiments of the method are practiced using a forecasting software component on a computer. Results of the forecasting method can be displayed using different computer software interfaces.

### CROSS-REFERENCE TO RELATED APPLICATION(S)

This application claims priority to Canadian Patent Application No. 2,987,761 filed on Dec. 6, 2017, the content of which is herein incorporated by reference in its entirety.

### FIELD OF THE INVENTION

This invention is in the field of precision agricultural forecasting methods and tools for use with field crops, and more specifically deals with a method of forecasting crop yield potential within a growing season using plant-available water metrics, and various software embodiments of same.

### BACKGROUND

Agricultural production methods and agronomic practices become more sophisticated every year - many types of very sophisticated crop management practices have been developed based upon variable rate crop inputs, planting zones, crop types and the like and it is in this general field of the present invention is located. There is ongoing interest and need to optimize and maximize field crop production in agriculture.

There are only a few variables which an agricultural producer can use or work in developing and executing the crop production strategy. Soil type and field characteristics are very important factors along with the type of the crop which is being planted. Water is arguably the most important yield-limiting factor for crop production in many geographic areas including the North American Prairie growing regions. Once a crop has been planted at a particular field location, in-season adjustments or variables are limited to fertilizer or nutrient application, herbicides or pesticides etc., or in some environments where equipment are available irrigation can also be used. Dependent upon the desired crop yield outcome, that is to say, the desired yield, quality or the like of the crop, particular combinations of irrigation, inputs, nutrients might make ultimate economic sense for a farmer.

The water available to crops and the timing of its availability is believed to be two key metrics which can accurately forecast on a real-time basis the likely yield potential for a selected crop to field site growing season, to allow for economic monitoring and potential intervention. While many agricultural and agronomic decision-support tools in the past have been relied upon rainfall at a particular location to forecast crop performance and production, it is believed that if a method of estimating yield potential could be created that factored in the concept of plant-available water—which has not been done to date—this would be a significant advance in the available tools and decision-making supports for farmers.

The concept of plant-available water has been considered by academics in the field as a significant variable in the determination of crop yield, and it is believed that if an effective agricultural decision support tool which relied upon plant-available water as a primary decision metric could be developed this would be a very desirable tool for use by many agricultural producers. If a particular field site dries out to its permanent wilting point, most crops will experience a yield loss. In many crop scenarios, to maximize crop yield it is important that the water content at a particular field site be maintained somewhere between at the upper boundary, the field capacity of the field, and at the lower boundary, the permanent wilting point.

Agricultural producers are moving more and more toward the deployment of computers and software tools in the planning and execution of their cropping. Computer software tools and use of computers and analytics provide for a large number of additional options and for metrics and mathematics of a higher level of complexity than those which might have been used when manual planning tools, forms and other documents would have been used. The widespread acceptance of software tools in the agriculture industry provides an opportunity in many areas, including the area of crop planting and economics. A computerized method of estimating yield potential using plant-available water to forecast the yield potential for a crop would be desirable from a commercial perspective.

One of the other benefits or outcomes in developing precision agriculture tools and a precision agriculture industry deploying more sophisticated tools is an increased ability to focus on field level analysis and practices in the execution of cropping plans. Where in the past farmers may have made their planting decisions or crop management decisions on a higher macro level, perhaps encompassing the entire farm at the same time, with the added availability of computerized tools and increased precision in many of the available agronomic calculations and methods, there is an increased level of granularity available in farming practices, to where crops are typically managed at least on the field level if not even by being managed in different zones within individual planting fields.

Continued evolution in field level agricultural cropping practices and enhancements is the desired outcome of the present invention—by making available methodology and tools which allow for microlevel planning farmers become more and more efficient and more and more profitable, with the added benefit of producing higher qualities and volumes of crops with given field areas and input availabilities etc. Achieving these objectives in a method that also allowed for enhanced environmental stewardship, by optimized use of water, fertilizer and other crop inputs would be favourably received.

### SUMMARY OF THE INVENTION

As outlined above, the concept of the present invention is a method of forecasting crop yield potential (YP) within a current growing season for a selected crop growing at a field site. The method uses plant-available water calculations to provide its results.

It is explicitly contemplated that the method of the present invention could be implemented using a computer and related forecasting software, in respect of a single field site or could be configured to provide the method-based forecasting of the present invention for multiple crops and multiple field sites.

In its broadest sense, the present invention comprises a method of estimating yield potential (YP) for a selected crop growing at a field site for a current growing season having a planting date and a completion date, said method comprising:
a. in a capture step conducted at a sample date, capturing at least one moisture reading in relation to a sample depth within a rooting depth of the field site;
b. in a calculation step:
   i. using the at least one moisture reading captured in relation to the rooting depth and other necessary method parameters, calculating the raw soil water value (W_{Raw}) within the rooting depth, being the amount of plant-available water within the rooting depth at the sample date;
   ii. calculating the total available moisture (M_{Total}) using the raw soil water value (W_{Raw}), the precipitation received (P_{R}) at the field site to date within the current growing season, and the forecast precipitation (P_{F}) at the field site for the remainder of the current growing season;
   iii. calculating the yield potential (YP) for the crop in the growing season based on the total available moisture (M_{Total}).

Generation of the plant available water driven yield potential calculation in accordance with this embodiment relies either upon manual soil samples from at least one sample depth in the rooting depth of the field, or in other embodiments could rely upon at least one moisture reading captured using an in-ground moisture sensor.
2. The method of claim 1 wherein the moisture reading for a sample depth is determined using a manually extracted soil sample.
3. The method of claim 1 wherein the moisture reading for a sample depth is captured using at least one in-ground moisture sensor.

The first step of many embodiments of the method of the present invention comprises determining a number of method parameters. The length and the specific calendar dates of the growing season for the selected crop at the field site are required—both the planting date and the anticipated completion date are required. The planting date and the completion date will define the length of the growing season, as well as defining the corresponding calendar-based precipitation sampling used in a historical dataset to compare current year or current season precipitation information to historical precipitation information. The current growing season might be within a calendar year or might span adjacent calendar years—in either case, the historical data which is used to prepare the necessary comparative historical precipitation information would rely upon a similar chronological date range across earlier growth years. In addition to the planting date and the completion date, a calculation date is the particular date within the growing season which is used for calculation purposes and for determining, for example, the date before which actual season to date precipitation figures can be used in the forecasting method, and following which forecast or estimated precipitation to the conclusion of the growing season will be used.

The method parameters to be determined also include the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season. Historical precipitation data for more than one historical growing season could also be used once averaged or otherwise normalized, and both such approaches are contemplated within the scope of the present invention. The historical precipitation data source could be a database or data structure, where the method is being executed by computer software, or if a manual calculation or execution of the method were being used, a printed or static form dataset could also be used.

Each selected crop type will have a base amount of available water which is required to establish initial crop growth, which is referred to herein as the initial moisture factor (MF) for the selected crop. Initial moisture factors for various selected crop types can be maintained in a table in a data source or otherwise captured or indicated for use in accordance with the remainder of the forecasting method of the present invention.

Another method parameter which is required to be determined for the practice of the method of the present invention is the historical yield (Y_{Hist}) for the selected crop. The historical yield (Y_{Hist}) for the selected crop relates to the historical yield of the selected crop grown either at a typical field site by or selected by the producer. Additionally it is necessary to ,capture or determine a permanent wilting point (WP) of the field site, which relates to the inferior limit of crop available water in any given soil. At the wilting point the soil is dry, an,d plants can no longer extract any more water. The wilting point of a given soil is variable related to the soil texture, soil structure and organic matter content.

Additional agronomic variables related to the crop selected or the field site selected, or other agronomic adjustments can be characterized as a subjective agronomic factor (F_{Ag}), which can be used as a multiplier in accordance with the formula of the present invention—t a default value of 1, no subjective agronomic adjustment is going to be applied to the results of the method, whereas by using a subjective agronomic factor above or below 1, the outcome of the results in an understood way can be affected. Many types of additional agronomic variables are contemplated to be potentially used in the method, and could be selected from the group of the soil type of the field site, field stresses for the field site, soil test values for the field site, planned fertilizer application rates for timing at the field site within the current growing season, or specific growing characteristics of the selected crop. It will be understood to those skilled in the art that there may be additional additional agronomic variables which can also be used in the method as outlined herein and any such characteristics or expansion of the potential parameters in the mathematical model outlined herein are contemplated within the scope of the present invention. If the subjective agronomic factor (F_{Ag}) is used, the formula used to calculate the yield potential of the crop would need to be modified to incorporate this factor.

Following the determination of the method parameters, a crop water use efficiency factor (F_{UE}) is calculated using the formula:

$${F}_{UE} = \frac{{Y}_{Hist}}{{P}_{Hist} - MF}$$

The crop water use efficiency factor (F_{UE}) is a numerical multiplier representing the historical yield of the crop in question, per unit of in-season historical available water.

Following the establishment of the crop water use efficiency factor (F_{UE}), the next steps of the method of the present invention relate to the current growing season. Specifically the raw soil water value (W_{Raw}) within a rooting depth of the field site at the planting date, based on at least one moisture reading captured in relation to a sample depth within the rooting depth, is determined. In addition to the raw soil water value (W_{Raw}), the precipitation received (P_{R}) at the field site, from the planting date to the calculation date will be determined, based on data stored within a current precipitation data source containing daily actual precipitation amounts for the field site for each calendar day of the current growing season.

The final variable necessary to be determined is the forecast precipitation (P_{F}) at the field site from the calculation date to the completion date, which could either be done using historical precipitation from the historical precipitation data source for the remaining date range from the calculation date to the completion date, or could be determined based on other calculations or forecast information. The specifics of different methods for determining the forecast precipitation are outlined in further detail elsewhere herein.

The total available moisture (M_{Total}) represents the total amount of crop available water for the current growing season which will be available to the crop at the field site. The total available moisture (M_{Total}) would be calculated, in a next step, using the formula:

M_{Total}=((W_{Raw}−WP)+P_{R}+P_{F})−MF

The yield potential (YP) is effectively a forecast of the yield potential for the selected crop at the field site within the current growing season based upon the current precipitation received in the growing season and the estimated precipitation to the conclusion of the growing season, compared to historical precipitation and available water figures. The subjective agronomic factor as outlined above can be applied to increase or decrease the forecast yield potential based upon other factors. Total available moisture (M_{Total}) is used in the final determination of the yield potential (YP) using the formula:

YP=M_{Total}*F_{UE}

In alternate embodiments of the method in which the method parameters include a subjective agronomic factor (F_{Ag}), the calculation of the yield potential (YP) would be executed using the formula:

YP=M_{Total}*F_{UE}

One or more sample depths within the rooting depth could be used to determine the raw soil water value (W_{Raw}) within a rooting depth of the field site. One or more inground sensors can be used—for example, a single inground sensor may be capable of capturing moisture readings at more than one sample depth, or in other cases where inground sensors were used, multiple sensors could be used to capture the necessary moisture readings at the multiple sample depths. Alternatively, other embodiments of the method could use aboveground sensor technology, or manual soil test results, to establish the moisture readings at least one sample depth in the rooting depth of the field site.

In order to practice the method of the present invention, previous average precipitation data on a daily basis for at least one prior growing season would be desirable. The precipitation data might be environmental rain data which was captured from a rain sensor at or near the field site. In other cases, the historical precipitation data source might be a weather dataset which simply relied upon sensors and other methods to provide geographically proximate calendar-based precipitation data to the field site—for example in certain cases there are networks of precipitation sensors used by weather reporting agencies that allow for extrapolation of reasonably geographically precise historical precipitation data, and it is also contemplated that this type of the data source could be used as the historical precipitation data source. The historical precipitation data source is likely an electronic data source which contains precipitation data from at least one precipitation sensor proximate to the field site.

The current precipitation data source comprises precipitation data from at least one precipitation sensor proximate to the field site, capturing precipitation data in the current growing season as the crop is grown. The current precipitation data source could also be a computer readable data set, accessible locally by computer or also accessible via a data network.

There is also disclosed a method of establishing a crop water use efficiency factor (F_{UE}) which can be used to transform total available moisture, based on actual precipitation and available in-ground water up to a calculation date and estimated or forecast precipitation to the completion of the growing season, for a current growing season to a forecast yield potential. Establishment of the crop water use efficiency factor (F_{UE}) is itself considered to be novel and patentable over the current state of the art for use in the method of the present invention and for other agronomic forecasting purposes. The first step of this aspect of the invention comprises determining a plurality of method parameters, including at least: the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;an initial moisture factor (MF) for the selected crop, being the required amount of available water for the selected crop to establish initial crop growth; and a historical yield (Y_{Hist}) for the selected crop. Following the determination of the method parameters, the crop water use efficiency factor (F_{UE}) is calculated using the formula:

$${F}_{UE} = \frac{{Y}_{Hist}}{{P}_{Hist} - MF}$$

The crop water use efficiency factor (F_{UE}) is a numerical multiplier representing the historical yield (Y_{Hist}) of the crop in question, per unit of in-season historical precipitation and available water, and can be used to forecast yield potential (YP) for a selected crop in a current growing season by multiplying the total available moisture (M_{Total}) for the current growing season with said crop water use efficiency factor (F_{UE}).

A further embodiment of a computerized method of the present invention, a method of estimating yield potential within a current growing season for a selected crop planted at a field site, uses a computer comprising a number of key systems and components. The computer comprises a connection to a historical precipitation data source which contains daily average precipitation amounts for at least one historical growing season at the field site in question. The historical precipitation data source might be locally hosted on the computer, or could be a remote data source accessible locally or remotely via a computer network and the appropriate communications infrastructure and software. The historical precipitation data source could comprise a third party data provider such as a weather service or the like, providing API or appropriate access to a historical precipitation data source. The computer also comprises a connection to a current precipitation data source which contains daily actual precipitation amounts for the field site in question for each calendar day of the current growing season. Current precipitation information for the field site or sites in question. The current precipitation data source might be locally hosted on the computer, or could be a remote data source accessible locally or remotely via a computer network and the appropriate communications infrastructure and software.

The invention also comprises a software method of calculating the forecast yield potential (YP) for a selected crop in a field site in a current growing season, wherein software executable on a computer provides a one-off execution of the forecast yield potential calculation, for display or other use by a user. This particular software-based method of the present invention comprises a first data capture step, wherein a user via a user input interface provides to the computer for storage or use at least the following method parameters in respect of the selected crop and the field site:
a. a planting date and a completion date defining the current growing season, and a calculation date being the effective date of the estimate calculation;
b. the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;
c. an initial moisture factor (MF) for the selected crop, being the required amount of available water for the selected crop to establish initial crop growth;
d. a historical yield (Y_{Hist}) for the selected crop;
e. a permanent wilting point (WP) of the field site; and
f. the raw soil water value (W_{Raw}) within a rooting depth of the field site at the planting date, based on at least one moisture reading captured in relation to a sample depth within the rooting depth.

Following the capture of the method parameters, the forecasting software component and the computer will conduct a current season moisture determination step, wherein for the current growing season the software will determine the precipitation received (P_{R}) at the field site from the planting date to the calculation date, based on data stored within a current precipitation data source containing daily actual precipitation amounts for the field site for each calendar day of the current growing season; and determine the forecast precipitation (P_{F}) at the field site from the calculation date to the completion date. As outlined above the forecast precipitation (P_{F}) could be determined based upon information stored within the historical precipitation data source for the same calendar date range of the remaining amount of time in the current growing season based on the calculation date and completion date of the season, or the forecast precipitation (P_{F}) can also be ascertained from a precipitation forecast data source as outlined elsewhere herein.

The software of the present method will next, in a calculation step, calculate a crop water use efficiency factor (F_{UE}) using the formula:

$${F}_{UE} = \frac{{Y}_{Hist}}{{P}_{Hist} - MF}$$

Following calculation of the crop water use efficiency factor (F_{UE}), the software will next calculate the total available moisture (M_{Total}) using the formula:

M_{Total}=((W_{Raw}−WP)+P_{R}+P_{F})−MF

Finally, the yield potential (YP) is calculated by the software executed on the computer, using the formula:

YP=M_{Total}*F_{UE}

The calculated yield potential (YP) will then be displayed to the user by a user display of the computer, or otherwise stored or used by the computer and the forecasting software component.

Some embodiments of this method of the present invention may also incorporate a subjective agronomic factor (F_{Ag}) into their calculations to accommodate the fine tuning of the forecasting calculations to accommodate the reflection of additional agronomic variables in the forecast calculated yield potential (YP) for a selected crop. It is explicitly contemplated that the subjective agronomic factor (F_{Ag}) could be a multiplier applied to the calculation of yield potential (YP)—the multiplier could begin with a default value of 1 where no modification of the forecast yield potential to reflect additional agronomic variables is required. Many types of additional agronomic variables are contemplated to be potentially used in the method as outlined. The subjective agronomic factor (F_{Ag}) itself, or an indication of the additional agronomic variables used to calculate the subjective agronomic factor (F_{Ag}), could also be captured as method parameters captured by the user input interface of the computer in the method outlined. In embodiments of the method incorporating the use of a subjective agronomic factor (F_{Ag}), the calculation of the yield potential (YP) would be determined using the formula:

YP=M_{Total}*F_{UE}*F_{Ag}

In a further software embodiment of the invention, the computer also includes a crop database accessible to the computer, which comprises at least one crop record related to a selected crop planted at a field site which would be forecast in accordance with the remainder of the method of the present invention—the information stored within the crop record would include at least the following method parameters for use in forecast calculations related to the selected crop and field site:
a) the planting date and the completion date of the current growing season;
b) a crop water use efficiency factor (F_{UE}) for the selected crop at the field site calculated using the formula:

$${F}_{UE} = \frac{{Y}_{Hist}}{{P}_{Hist} - MF}$$

where:
Y_{Hist} is a historical yield for the selected crop;
P_{Hist} is the historical seasonal precipitation being the total of daily average precipitation amounts for a calendar date range defined by the planting date to the completion date of the current growing season, based on data stored within a historical precipitation data source containing daily average precipitation amounts for the field site for each calendar day of at least one previous growing season; and
MF is an initial moisture factor for the selected crop, being the required amount of available water for the selected crop to establish initial crop growth;
c) the raw soil water value (W_{Raw}) within a rooting depth of the field site at the planting date, based on at least one moisture reading captured in relation to a sample depth within the rooting depth; and
d) a permanent wilting point (WP) of the rooting depth of the field site.

In addition to the crop database, a yield potential database comprises at least one yield potential record corresponding to a calculation executed in accordance with the method of the present invention and which contains at least a link to a crop record, a calculation date, and the forecast yield potential (YP) of the selected crop in the current growing season as of the calculation date. Both the crop database and the yield potential database could be locally hosted or resident on and administered by the computer, or could be accessed locally or remotely via a network interface.

The computer would also contain a forecasting software component capable of facilitating the necessary calculations and data transactions in the administration and execution of the method of the present invention. The computer and the forecasting software component would execute a yield potential forecasting calculation upon the occurrence of a trigger condition in respect of a crop record from the crop database. The trigger condition might either be a manual user trigger, a pre-programmed frequency or another event occurrence which has been preprogrammed as the initiating step upon which a calculation should be executed.

Upon the detection or occurrence of a trigger condition in respect of a crop record, the computer using the forecasting software component would execute a calculation by in conjunction with user input or stored data as required:
a) capturing a calculation date;
b) determining the precipitation received (P_{R}) at the field site from the planting date to the calculation date, based on data stored within a current precipitation data source containing daily actual precipitation amounts for the field site for each calendar day of the current growing season;
c) determining the forecast precipitation (P_{F}) at the field site from the calculation date to the completion date—either by forecast information or by accessing historical precipitation data or other information sources;
d) calculating the total available moisture (M_{Total}) using the formula:

M_{Total}=((W_{Raw}−WP)+P_{R}+P_{F})−MF
e) calculating the yield potential (YP) using the formula:

YP=M_{Total}*F_{UE}

A related yield potential record would then be created in the yield potential database, linked to the related crop record and storing the calculated yield potential (YP) along with the other record contents.

Some embodiments of the method of the present invention may also incorporate a subjective agronomic factor (F,_{Ag}) into their calculations to accommodate the fine tuning of the forecasting calculations to accommodate the reflection of additional agronomic variables in the forecast calculated yield potential (YP) for a selected crop. The subjective agronomic factor (F_{Ag}) could be stored in the crop record, or an indicator of the applicable additional agronomic variables could be stored in the crop record to allow for the dynamic determination of the subjective agronomic factor (F_{Ag}) at the time of the completion of a forecast calculation in accordance with the method. In embodiments of the method incorporating the use of a subjective agronomic factor (F_{Ag}), the calculation of the yield potential (YP) would be executed using the formula:

YP=M_{Total}*F_{UE}*F_{Ag}

The crop water use efficiency factor could be calculated for storage within the crop record at the time of creation of the crop record by:
a) using the computer to calculate or user interface to capture at least the following additional method parameters:
   i. the historical seasonal precipitation (P_{Hist}) being the total of daily average precipitation amounts for a calendar date range defined by the planting date to the completion date of the current growing season, based on data stored within a historical precipitation data source containing daily average precipitation amounts for the field site for each calendar day of at least one previous growing season;
   ii. an initial moisture factor (MF) for the selected crop, being the required amount of available water for the selected crop to establish initial crop growth; and
   iii. a historical yield (Y_{Hist}) for the selected crop;
b) calculating the crop water use efficiency factor (F_{UE}) using the formula:

$${F}_{UE} = \frac{{Y}_{Hist}}{{P}_{Hist} - MF}$$

c) storing the crop water use efficiency factor (F_{UE}) to the crop record for use in subsequent calculations.

The historical precipitation data source would contain historical precipitation data from at least one precipitation sensor proximate to the field site. The at least one precipitation sensor could be a rain sensor or otherwise. Any type of sensor or data acquisition methodology which results in the ability to capture to the historical precipitation data source historical precipitation data for use in accordance with the remainder of the method of the present invention is contemplated within the scope hereof. Similar to the historical precipitation data source, the current precipitation data source also contains precipitation data from at least one precipitation sensor proximate to the field site.

The calculated forecast yield potential (YP) which has been stored in a yield potential record could be displayed to a user via a user interface of the computer or a connected client device. A user interface operatively connected to the computer might also include a graphical interface allowing for the graphical display of the contents of multiple yield potential records pertaining to a particular selected crop in a field site within a growing season to a user.

A further embodiment of the present invention is the actual forecasting software component itself—namely a non-transitory computer-readable storage medium storing processor instructions for use in the operation of a computer in a method of estimating yield potential within a current growing season for a selected crop planted at a field site, the computer-readable storage medium including instructions that when executed by a computer cause the computer to execute any of the embodiments of the method outlined herein and above. In many embodiments of the software of the present invention, the calculated yield potential would be stored in the memory of the computer.

The forecasting software component could also display the forecast yield potential (YP) calculated in the execution of the method to a user of the computer. Multiple forecast yield potentials could be calculated, stored and displayed graphically as well. One of the primary benefits of the method of the present invention is that it allows for very granular yield potential forecasting in respect of field crops. In addition, the granularity and accuracy of the calculations by using plant-available water calculations rather than overall precipitation information will also represent a significant advance over the current state-of-the-art.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labelled with like numerals, and where:

FIG. 1 is a graph demonstrating the concept of plant-available water in a growing location, as outlined in further detail herein;

FIG. 2 is a flowchart demonstrating the steps in one embodiment of the forecasting method of the present invention;

FIG. 3A is a graphic extracted from an information management system in accordance with the present invention demonstrating captured sensor readings and the calculation of the raw soil water value (W_{Raw}) within a rooting depth of the field site at the planting date, in a field site, in accordance with the present invention;

FIG. 3B is a chart demonstrating a sample of numerical values in the calculation of crop yield potential (YP) in accordance with one embodiment at a particular date in accordance with the present invention;

FIG. 3C is a chart demonstrating numerical values and the calculation of crop yield potential (YP) at a later date in the growing season in accordance with the earlier data captured and outlined in FIGS. 3A and 3B;

FIG. 4 is a flowchart showing an alternate embodiment of the method of FIG. 2 in which a subjective agronomic factor (F_{Ag}) is applied to the yield potential forecast calculation;

FIG. 5 is a flowchart demonstrating the steps in one embodiment of the method of creation of a crop water use efficiency factor (F_{UE}) for use in yield potential (YP) forecasting calculation;

FIG. 6 is a flowchart demonstrating steps in one embodiment of the computer-driven forecasting method of the present invention, where a single forecasting transaction is executed;

FIG. 7 is a flowchart showing the steps in an alternate embodiment of the method of FIG. 6, wherein additional agronomic factors are used to establish and use a subjective agronomic factor (F_{Ag}) in the forecasting calculation;

FIG. 8 is a flowchart demonstrating steps in a further embodiment of the computer-driven forecasting method of the present invention, including a crop database and a yield forecast database and using a monitoring loop and trigger conditions to trigger forecasting calculations;

FIG. 9 is a flowchart demonstrating steps in an alternate embodiment of the computer-driven forecasting method of FIG. 8;

FIG. 10 is a flowchart demonstrating the steps in a further embodiment of the method of the present invention;

FIG. 11 is a block diagram of one embodiment of a system architecture in accordance with the present invention;

FIG. 12 it is a schematic drawing of one embodiment of the computer in accordance with the present invention;

FIG. 13 is a diagram demonstrating the key components of an embodiment of the data structure of the crop database;

FIG. 14 is a diagram demonstrating the key components of an embodiment of the data structure of the yield potential database;

FIG. 15 is a sample of a screenshot of a user display in accordance with the present invention, allowing for data entry and configuration of a crop record in accordance with the remainder of the invention;

FIG. 16 is a sample of a screenshot of one embodiment of a user interface in accordance with the present invention, in which a producer could review summarized information with respect to multiple crops and field sites being managed in accordance with the method of the present invention;

FIG. 17 is one example of a screenshot in a representative user interface in accordance with the software of the present invention, showing a graph of calculated and forecast water statistics and yield potential within a growing season based upon calculations administered in accordance with the method outlined herein; and

FIG. 18 is a sample of a screenshot in a representative user interface in accordance with the software of the present invention, such as that shown in FIG. 17, including an exploded data call out demonstrating detailed calculations and information in accordance with the method of the present invention at a particular calculation date.

### DETAILED DESCRIPTION OF ILLUSTRATED EMBODIMENTS

The amount of water available to crops, as well as the timing of its availability, are believed to be two key metrics which can be used to accurately forecast on a real-time basis the likely yield potential for a selected crop at a field site in a growing season. Use of plant-available water statistics, rather than simple precipitation figures, provides a higher additional degree of granularity and accuracy in the forecasting which can be undertaken and can provide a forecast yield potential which more accurately estimates the potential yield of a crop even in circumstances of high precipitation figures resulting in excess amounts of moisture over the field capacity, or in drought scenarios where the amount of precipitation, taking into account field conditions, crop conditions and the like are insufficient to get above the permanent wilting point of the particular crop and field conditions.

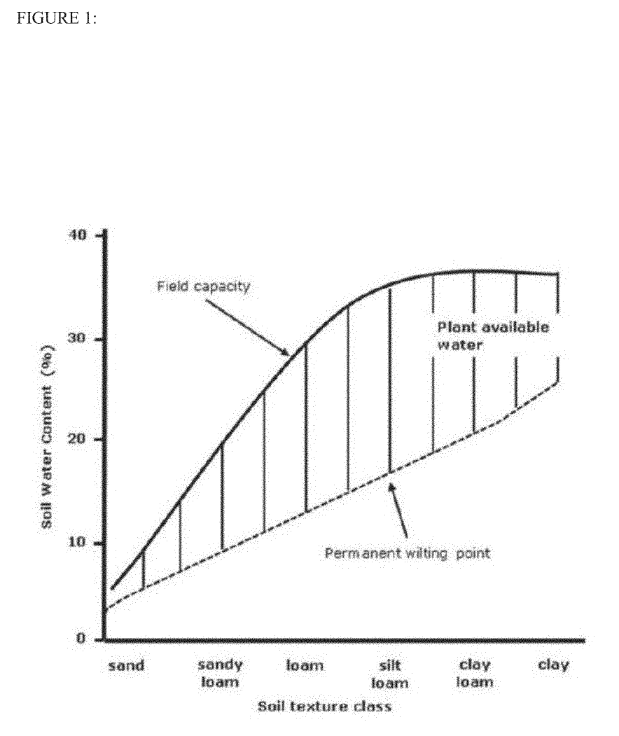

The use of plant-available water as an agronomic metric or tool will be understood to those skilled in the art, along with factors affecting its calculation, and it will be understood that the broadest concept of the present invention is intended to encompass any type of a crop yield potential forecasting method based upon plant-available water calculations within a current or historical growing season. There are several factors in the determination of plant-available water, key amongst which is the soil type. Lighter styles of soil allow for the retention of less volume of water than for example clay or other more dense soil types which will inhibit the passage of water therethrough and allow for the longer-term availability of moisture within the soil. FIG. 1 demonstrates the correlation between plant-available water, between the field capacity and wilting point, and soil type of the field.

The present invention comprises a method of estimating yield potential (YP) within a current growing season for a selected crop growing in a field site embodied in a computer software forecasting tool. The yield potential (YP) forecast of the present invention is “water-driven” insofar as it relies upon real-time calculations of plant-available water to forecast the likely yield outcome of a particular selected crop at a field site in a current growing season.

Where used elsewhere in this specification and to outline the intended scope of the present invention, the following terms are defined as follows:
a) “calculation date” means the calendar date at which the sampling or relevant forecasting calculation will be conducted, being a calendar date between the planting date and the completion date;
b) “growing season” means the length of days defined by planting date and completion date, which define the current growing season. In certain cases and with certain selective crops more than one crop could be grown in a calendar year, or a growing season could extend between adjacent calendar years [with the attendant and understood modifications to the remainder of the method]. Relating the growing season of the selected crop to the calendar year is necessary since it is specifically contemplated that the historically available moisture figures contained within the historical precipitation data source would be captured or linked to calendar days, whereby for example if the growing season was defined as May 1 to September 15 for the selected crop in the current year, the historical data source could be assessed on the basis of precipitation in one or more previous calendar years in the same May 1 to September 15 window;
c) “historical seasonal precipitation (_{PHist})_{”} means the amount of precipitation at the field site selected for a selected crop between the same planting date and completion date in a prior calendar year, based on data stored within a historical precipitation data source containing daily average precipitation amounts for the field site for each calendar day of at least one previous growing season;
d) “historical yield (Y_{Hist})” means the historical yield of the selected crop at a typical field site of the producer or selected by the producer, which is used to calculate the historical water-driven crop production of the selected crop for translation into the current growing season;
e) “initial moisture factor (MF)” means the required amount of available water for a particular selected crop to establish initial crop growth;
f) “permanent wilting point (WP)” corresponds to the inferior limit of crop available water in a given soil. At the permanent wilting point, the soil is dry, and plants can no longer extract any more water. The permanent wilting point of a given soil is primarily related to soil texture. It may also be impacted by soil structure, organic matter content, or other factors;
g) “planting date” means the calendar date of planting of the selected crop at the field site;
h) “precipitation received (P_{R})” means the actual amount of precipitation received at the field site for a select crop for the current growing season, from the planting date to the calculation date;
i) “forecast precipitation (P_{F})” means the estimated amount of precipitation anticipated to be received at the field site for a selected crop for the remainder of the current growing season, from the calculation date to the season and date—either calculated based upon the same calendar date range from the historical precipitation data source, or based upon current season precipitation forecast information;
j) “raw soil water value (W_{Raw})” means the amount of plant-available water within the rooting depth of the field site at a particular date—effectively it comprises the moisture within the field site that is between, at the bottom of the range, the permanent willing point, and at the top of the range the maximum holding capacity of the field;
k) “rooting depth” means the depth of the field site within which the selected crop will grow;
l) “sample depth” means a particular depth level within the rooting depth of the field site, at which current moisture levels are measured for the purpose of ascertaining the raw soil water value within the rooting depth of the field;
m) “completion date” means the estimated calendar date of the completion of the growing season of the selected crop at the field site in the current growing season. The completion date of the growing season could be estimated based upon understood times for growing of the selected crop from planting to harvest. The end date of the growing season could be adjusted during the growing season, if required;
n) “selected crop” means any field crop which could be monitored and facilitated in accordance with the method of the present invention. Grains, pulses, vegetables, grasses and any other type of field crop are contemplated to be within the anticipated scope;
o) “subjective agronomic factor (F_{Ag})” means a multiplier or mathematical function which can be applied to a yield potential calculation which allows for the subjective influence of the yield potential forecasts of the present invention by additional agronomic variables;
p) “total available moisture (M_{Total})” means the sum of the raw soil water value less the wilting point of the field site, the precipitation received and the forecast precipitation at a field site, less the initial moisture factor; and
q) “yield potential (YP)” means the quantitative yield forecast for a selected crop at a field site, most often expressed in a production quantity of cropper unit of area of the field site (i.e. bushels per acres, tonnes per hectare, etc.)

### Crop Water Use Efficiency Factor:

The crop water use efficiency factor (F_{UE}) itself is a calculated value which based upon identified historical precipitation information and the other planting and cropping characteristics outlined can be applied to current seasonal precipitation information to yield an estimated yield potential for the crop at the conclusion of the current growing season in respect of which the forecast is conducted. The crop water use efficiency factor (F_{UE}) is calculated using the formula:

$${F}_{UE} = \frac{{Y}_{Hist}}{{P}_{Hist} - MF}$$

### Where:

Y_{Hist} is the historical yield of the selected crop;
P_{Hist} is the historical seasonal precipitation being the total of daily average precipitation amounts for a calendar date range defined by the planting date to the completion date of the current growing season, based on data stored within a historical precipitation data source containing daily average precipitation amounts for the field site for each calendar day of at least one previous growing season; and
MF is the initial moisture factor for the selected crop.

The crop water use efficiency factor (F_{UE}) represents a quantity of crop production per unit of net precipitation based on a historical season scenario, which can be applied to a current season's precipitation results to ascertain the likely yield outcome in the current growing season.

The current season yield potential (YP) for the crop in the method of the present invention is calculated by multiplying the current season's anticipated total available moisture (M_{Total}) by the crop water use efficiency factor (F_{UE}) . Creation of the crop (M _{Total}) water use efficiency factor (F_{UE}) based upon the mathematical approach and the plant-available water characteristics outlined herein, for use as an element in various agronomic or crop forecasting analysis functions, is explicitly intended to be covered within the scope of the present invention.

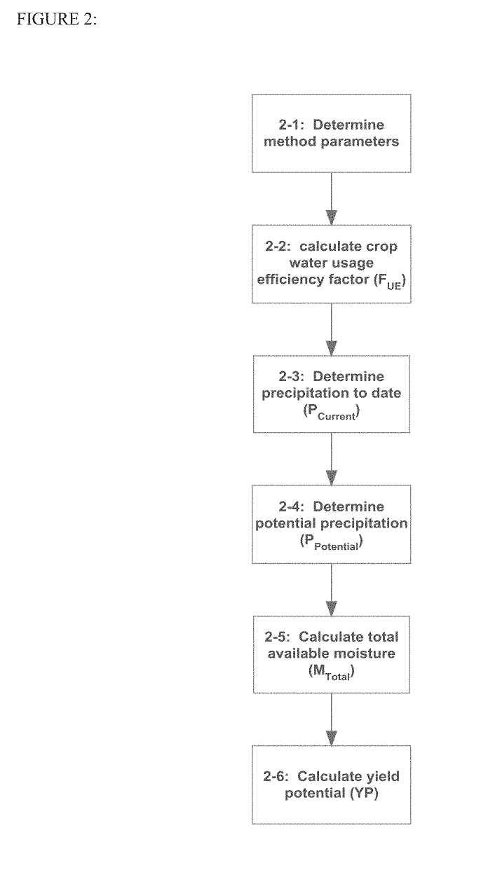

FIG. 2 demonstrates the steps in one embodiment of the forecasting method of the present invention. The first step of the method is to determine a plurality of method parameters for use in the execution of calculations in accordance with the remainder of the method. This is shown at 2-1. The method parameters required in these most basic embodiments of the method are the planting date and the completion date for the selected crop at the field site in the current year. A calculation date within the current growing season between the planting date and the completion date would also be determined.

The historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season, would be calculated from data stored within a historical precipitation data source. It is also necessary to capture or determine an initial moisture factor (MF) for the selected crop, a historical yield (Y_{Hist}) for the selected crop, a permanent wilting point (WP) of the field site, and the raw soil water value (W_{Raw}) within a rooting depth of the field site at the planting date based on at least one moisture reading captured in relation to a sample depth within the rooting depth.

The next step in the method of the present invention, shown at 2-2, is the calculation of the crop water use efficiency factor (F_{UE}). The crop water use efficiency factor (F_{UE}) is calculated using the formula:

$${F}_{UE} = \frac{{Y}_{Hist}}{{P}_{Hist} - MF}$$

Following the determination or establishment of the crop water use efficiency factor (F_{UE}), the precipitation received (P_{R}) at the field site to date in the current growing season will be determined, from the planting date to the calculation date based upon data stored within a current precipitation data source. This is shown at step 2-3. In addition, forecast precipitation (P_{F}) at the field site for the remainder of the current growing season will also be determined, from the calculation date to the completion date of the current growing season—shown at 2-4. This could either be estimated using historical average precipitation data from the historical precipitation data source, or in other embodiments as outlined elsewhere herein current season weather forecast information could also be used in both such approaches are contemplated within the scope of the present invention. It is explicitly contemplated that the historical average data stored within the historical precipitation data source will provide good information for the calculation of forecast precipitation (P_{F}) but those skilled in the art of extrapolation of weather forecast and precipitation forecast information from current season forecast data will understand that there are credible approaches to using forecast information to extrapolate the forecast precipitation (P_{F}).

The next step, shown at 2-5, is the calculation of the total available moisture (M_{Total}) using the formula:

M_{Total}=((W_{Raw}−WP)+P_{R}+P_{F})−MF

Finally, shown at 2-6, the crop water use efficiency factor (F_{UE}) would be applied to the total available moisture (M_{Total}) to yield the forecast yield potential (YP) for the selected crop for the current growing season using formula:

YP=M_{Total}*F_{UE}

The yield potential (YP) yielded by this calculation provides a forecast yield potential for the selected crop at the field site based upon the deviation of the precipitation between the planting date and the calculation date over the historical precipitation scenario encapsulated within the crop water use efficiency factor (F_{UE}).

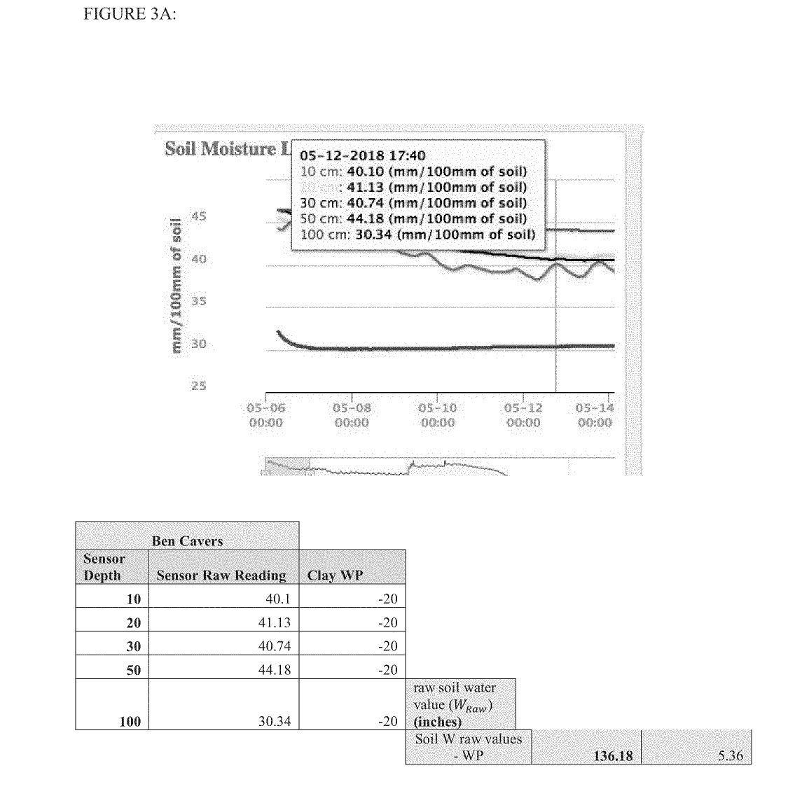

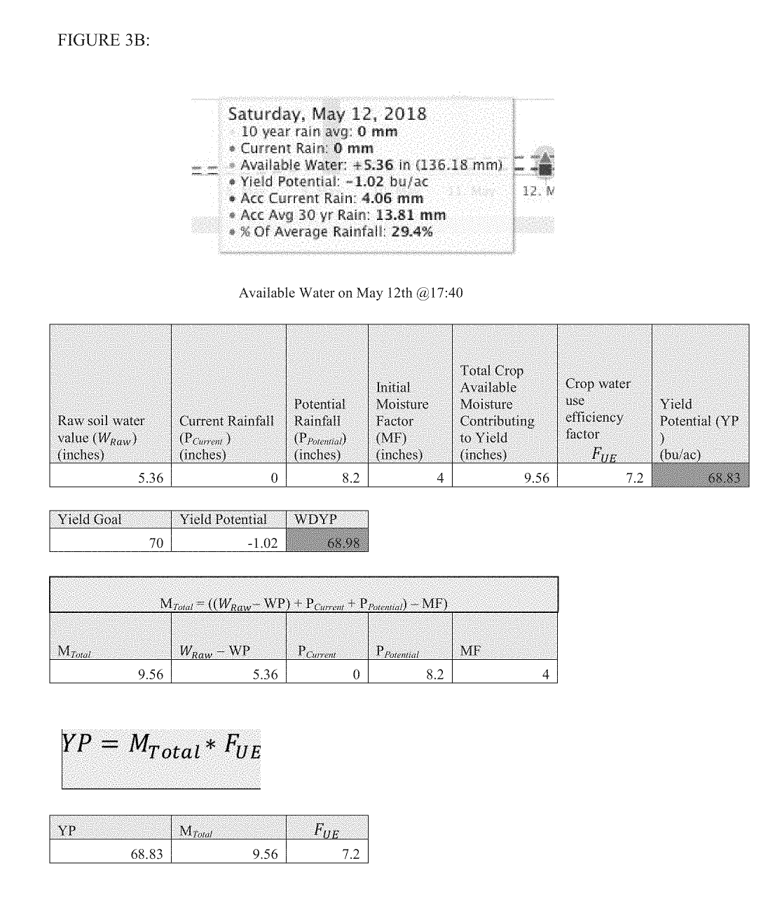

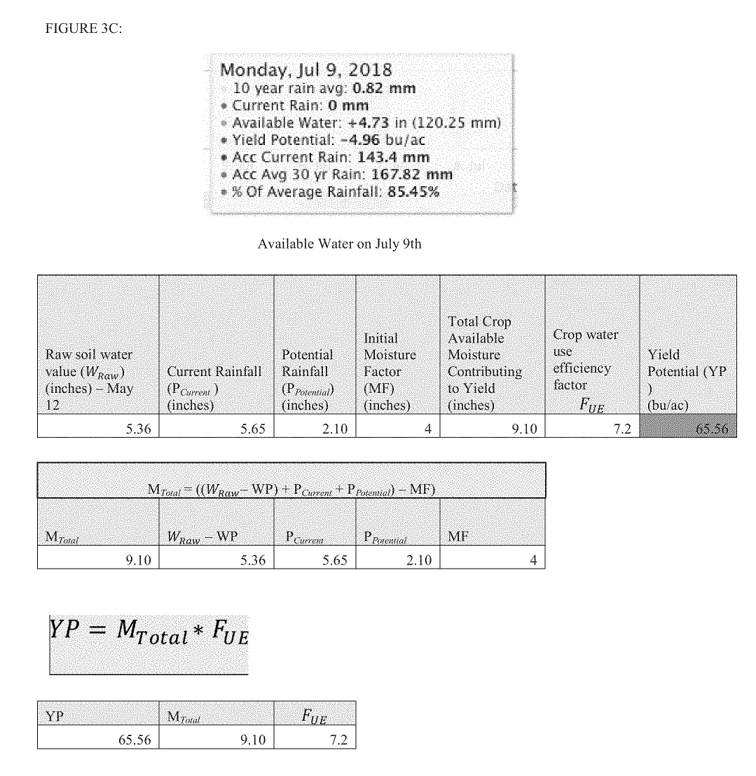

FIGS. 3A through 3C include the necessary data to demonstrate one sample calculation in accordance with the method of the present invention, being a water driven yield potential calculation based upon plant available water. Referring first to FIG. 3A, the data for the calculation of the raw soil water value (W_{Raw}) within a rooting depth of the field site at the planting date based on at least one moisture reading captured in relation to a sample depth within the rooting depth is shown. The date shown on this Figure, May 12, 2018, is the planting date for a selected crop at a field site, in respect of the examples provided. In the case of the sample calculations shown, five sensor depths are used to measure the soil moisture contents for calculation of the raw soil water value (W_{Raw})—measurements are taken as shown at 10, 20, 30, 50 and 100 cm. The five moisture sensor readings are combined to yield a raw soil water value (W_{Raw}) measurement of 5.36 inches. Where more than one moisture sensor reading is used in the generation of the raw soil water value (W_{Raw}) measurement, the moisture sensor readings could be weighted, averaged or otherwise transformed using a customized formula—where multiple moisture sensor readings are used, any means our method of converting those multiple readings into a usable raw soil water value (W_{Raw}) measurement for use in the remainder of the method of the present invention is contemplated within the scope hereof.

The measurement expressed in this Figure is in inches—it will be understood that the measurements used in the entire method of the present invention could be conducted in imperial or metric scales with appropriate conversions being applied. The raw soil water value (W_{Raw}) is effectively the moment-in-time water contents of the field site at the time the moisture measurements are taken, and for the purposes of the present invention and method would be captured at or near the planting date of the crop. Calculation of the raw soil water value (W_{Raw}) measurement would take place chronologically within the method of the present invention as described and outlined elsewhere herein. The raw soil water value calculated as of the planting date is used for calculations throughout the current growing season and the remainder of the method.

FIGS. 3B and 3C show the calculation of the yield potential (YP) for a selected crop at a field site at two different dates within a current growing season. Referring first to FIG. 3B the calculation of available water and yield potential at the date of May 12 is shown. As outlined above for the perspective of this Figure, May 12 is the planting date for the current growing season, so in addition to calculating the starting raw water values, in this particular calculation, the planting date and the calculation date are the same. As can be seen in the calculations outlined and enabled in this Figure, based upon the raw soil water value, a current rainfall value of zero given that the calculation date is the planting date, and an estimated potential rainfall for the remainder of the current growing season of 8.2 inches, the forecast yield potential for the crop in the current growing season is 68.83 bushels per acre. Moving forward in time to July 9, as shown in FIG. 3C, there is now current rainfall information available from May 12 to July 9, at a value of 5.65 inches, with the forecast potential rainfall for the remainder of the growing season at 2.1 inches. As can be seen, this represents a modest decrease, based on actual precipitation figures, and the estimated seasonal available water over the scenario first calculated at the commencement of the growing season, resulting in a modified and reduced yield potential calculation of 65.56 bushels per acre.

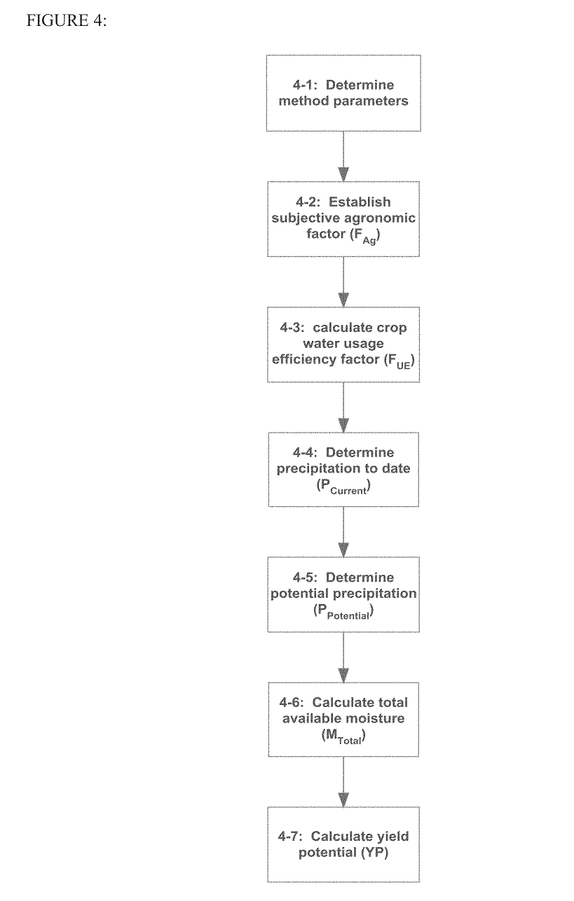

FIG. 4 demonstrates an alternate embodiment of the method of the present invention, incorporating the use of a subjective agronomic factor (F_{Ag}) to adjust for any additional agronomic variables which would alter crop water usage in the current growing season. These could be everything from the incorporation of additional individual measurable parameters at the crop site through to even something as simple as a “black box” multiplier or mathematical factor which certain agronomists might like to apply to fine tune or refine yield potential outputs. In embodiments such as that of FIG. 4 incorporating a subjective agronomic factor (F_{Ag}), the formula for calculation of the yield potential (YP) is calculated using the modified formula:

YP=M_{Total}*F_{UE}*F_{Ag}

The subjective agronomic factor (F_{Ag}) as a multiplier used in the formula for determination of yield potential, which might have a default value of 1, could be adjusted based on additional agronomic variables to either increase the forecast yield potential, by increasing the value of the subjective agronomic factor (F_{Ag}) above 1, or to decrease the forecast yield potential by decreasing the value of the subjective agronomic factor (F_{Ag}) below 1. Establishment of the subjective agronomic factor (F_{Ag}) is shown at 4-2 following the determination of the method parameters which might include the indicators of the additional agronomic variables required to establish the subjective agronomic factor (F_{Ag}), at 4-1. In other embodiments, rather than capturing the additional agronomic variables in the method parameters, capture of the method parameters might include the capture or determination directly of the subjective agronomic factor (F_{Ag})—such as for example where the agronomist advising the agricultural producer might wish to simply apply a specified “black box” variable or multiplier to the formula in question. All such approaches are contemplated within the scope of the present invention. The remainder of the steps of FIG. 4 is the same as that of FIG. 2, with the exception of the establishment of the subjective agronomic factor (F_{Ag}), and that the yield potential calculation in 4-7 would use the modified formula outlined above.

Determination of Crop Water Use Efficiency Factor:

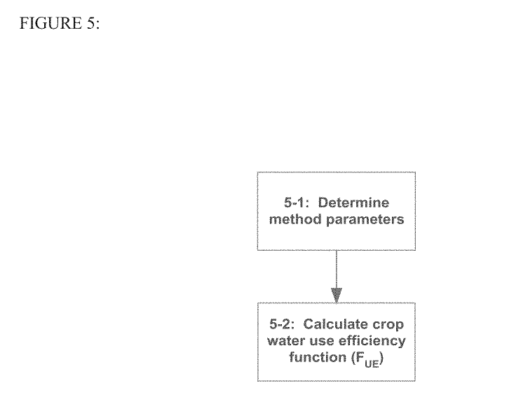

A computerized embodiment of the present invention as shown and described in relation to FIG. 5 is a method of the determination of a crop water use efficiency factor for use in agronomic forecasting applications. The crop water use efficiency factor (F_{UE}) is a numerical multiplier representing the historical yield of the crop in question, per unit of in-season historical precipitation and available water, and can be used to forecast yield potential (YP) for a selected crop in a current growing season by multiplying the total available moisture for the current growing season with said crop water use efficiency factor. Creation of the crop water use efficiency factor (F_{UE}) in respect of a particular crop could be done using computer software. Rendering of a crop water use efficiency factor (F_{UE}) which can be used to transform the total available moisture for a current growing season to a forecast yield potential for a selected crop at a field site within the current growing season, in accordance with the remainder of the present invention, would be executed in accordance with a method similar to that shown in FIG. 5. The method parameters would be calculated or captured, shown at step 5-1. As outlined above, the method parameters would comprise:
a. the historical seasonal precipitation (P_{Hist}) being the total of daily average precipitation amounts for a calendar date range defined by the planting date to the completion date of the current growing season, based on data stored within a historical precipitation data source containing daily average precipitation amounts for the field site for each calendar day of at least one previous growing season;
b. an initial moisture factor (MF) for the selected crop, being the required amount of available water for the selected crop to establish initial crop growth; and
c. a historical yield (Y_{Hist}) for the selected crop.

Following the determination of the method parameters, the crop water use efficiency factor (F_{UE}) is calculated using the formula:

$${F}_{UE} = \frac{{Y}_{Hist}}{{P}_{Hist} - MF}$$

The crop water use efficiency factor (F_{UE}) established in accordance with the method of FIG. 5 could be used in varying types of manual or automated forecasting practices.

The actual execution of the method of FIG. 5, namely rendering the crop water use efficiency factor itself, versus other embodiments outlined herein which use the rendered crop water use efficiency factor in more detailed calculations or embodiments, could also be executed by a computer with appropriate software. The historical precipitation data source used might include precipitation data from at least one precipitation sensor proximate to the field site. The historical precipitation data source could consist of precipitation data from one or more previous years—where more than one past season was covered in the historical data set, averaging or other statistic normalization could be applied.

Forecasting Yield Potential:

There are at least two different scenarios contemplated both which are described and demonstrated in further detail below—the first of which is a more basic embodiment of the yield potential forecasting method of the present invention wherein the necessary method parameters or variables for the execution of a single forecasting calculation or captured via the memory or a user input interface of a computer, and a second set of embodiments of the method of the present invention delivered using a forecasting software component which incorporates a crop database and yield potential database, for the ongoing periodic monitoring our calculation of yield potential forecast in respect of a plurality of crop and site combinations.

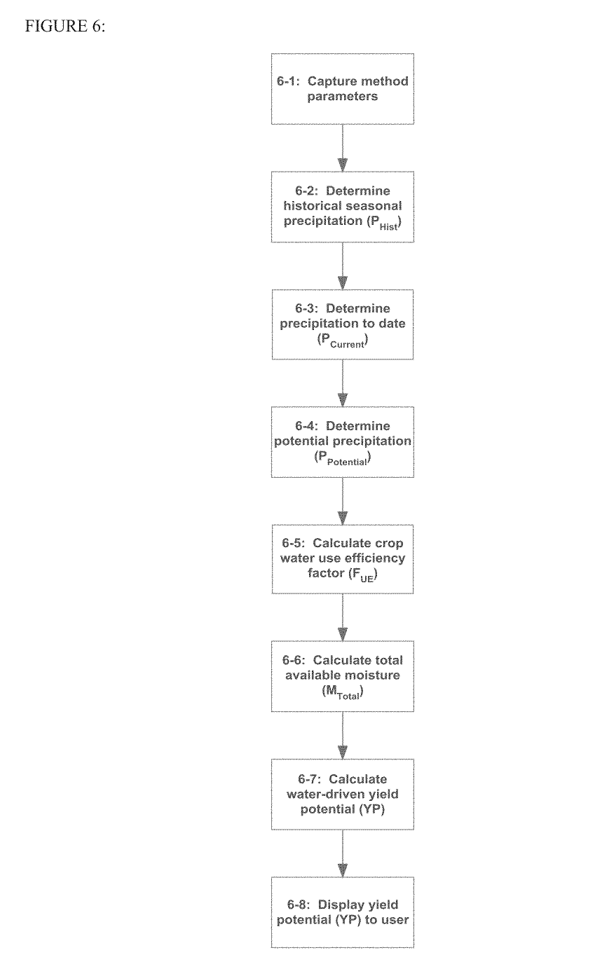

FIG. 6 is a flowchart demonstrating the steps of a first software-based embodiment of the yield potential forecasting method of the present invention. The method of using a computer to estimate yield potential (YP) for a selected crop growing at a field site for a current growing season uses a computer comprising at least one user input interface; a user display via which the results of the method can be displayed to a user; a connection to a historical precipitation data source containing daily average precipitation amounts for the field site for each calendar day of at least one previous growing season; a connection to a current precipitation data source containing daily actual precipitation amounts for the field site for each calendar day of the current growing season; and a forecasting software component within the memory of the computer capable of facilitating the necessary data transactions of the method.

The method comprises, by operation of the computer and the forecasting software component, a data capture step as shown in 6-1. In the data capture step, the forecasting software component via the user input interface would allow a user to enter the necessary method parameters that are required to execute a yield potential forecasting calculation in accordance with the forecasting method of the present invention. The method parameters that would need to be captured in this particular embodiment include the following:
1. a planting date and a completion date defining the current growing season, and a calculation date being the effective date of the estimate calculation;
2. an initial moisture factor (MF) for the selected crop, being the required amount of available water for the selected crop to establish initial crop growth;
3. a historical yield (Y_{Hist}) for the selected crop;
4. a permanent wilting point (WP) of the field site; and
5. the raw soil water value (W_{Raw}) within a rooting depth of the field site at the planting date, based on at least one moisture reading captured in relation to a sample depth within the rooting depth.

The user input interface of the computer could either be a local keyboard, mouse, monitor or combination of user input interface devices, or in other embodiments of the method of the present invention the computer hosting the forecasting software component might be a server and the user input interface might be a client interface provided via a client device operatively connected via a network to the server. Both such approaches are contemplated within the scope of the present invention. Some of the method parameters could be entered directly by the user input interface of the computer and other parameters could either be calculated based on information captured and stored within the memory of the computer or based on interim variables entered by the user via the user input interface. An embodiment of a method of computerized yield potential forecasting based on client available water calculation such as those outlined herein which relies upon any combination of manually entered and automatically calculated method parameters variables as outlined is contemplated within the present invention.

The data capture step could be conducted at the time of commencement of the forecasting calculation in accordance with the method, or in other embodiments of this particular method or approach some or all of the method parameters to be captured and stored in the memory of the computer so that they could be recalled by the forecasting software component for subsequent reuse and subsequent iterations of the forecasting transaction or calculation of the present invention.

Following the entry of the method parameters in the data capture step 6-1, additional variables need to be determined for use in accordance with the remainder of the forecasting calculation of the present invention. The three additional variables which are calculated in accordance with the moisture determination step are the historical seasonal precipitation (P_{Hist}), precipitation received (P_{R}), and forecast precipitation (P_{F}).

The computer and the forecasting software component will determine the historical seasonal precipitation (P_{Hist}) from the planting date to the completion date, based on data stored within a historical precipitation data source containing daily average precipitation amounts for the field site for each calendar day of at least one previous growing season.

The historical precipitation data source as outlined elsewhere herein will contain at least one previous calendar year of precipitation data for the date range of the growing season. If the historical precipitation data source contains more than one previous growing season of precipitation data it can be average for each calendar date—it is thought that if more than one year of historical precipitation data was average in historical precipitation data source even further accuracy in the long term historical forecasts of the present invention would be provided. The historical seasonal precipitation (P_{Hist}) will be the sum of daily precipitation amounts for each day from the planting date to the season and date specified in the method parameters, from the historical data contained within the historical precipitation data source. This is shown at 6-2.

In addition to the historical seasonal precipitation (P_{Hist}) , the forecasting software component will also determine the precipitation received (P_{R}) at the field site from the planting date to the calculation date, based on data stored within a current precipitation data source containing daily actual precipitation amounts for the field site for each calendar day of the current growing season. As outlined elsewhere herein, the current precipitation data source contains precipitation data captured within the current calendar year or current growing season at the field site. Various types of data capture methodologies can be used. The precipitation received (P_{R}) is the sum of the daily precipitation totals from the current precipitation data source, from the planting date to the calculation date. Establishment of this variable is shown in step 6-3.

The forecasting software component and the computer will also determine the forecast precipitation (P_{F}) at the field site from the calculation date to the completion date, which is the estimated amount of precipitation to be received from the calculation date to the completion date for the remainder of the current growing season at the field site. It is specifically contemplated that the forecast precipitation (P_{F}) could be calculated as a total of the daily precipitation amounts contained within the historical precipitation data source, for the calendar days corresponding from the calculation date to the completion date. The forecast precipitation (P_{F}) could also be queried or determined based upon a future forecasting data source. This is shown at Step 6-4.

Following the calculation or establishment of the required variables outlined above, the computer and the forecasting software component would next execute a series of calculations to finalize the yield potential (YP) calculation in accordance with the method of the present invention. Shown at step 6-5, forecasting software component would use the variables gathered and established as a method parameter to calculate the crop water use efficiency factor (F_{UE}) using the formula:

$${F}_{UE} = \frac{{Y}_{Hist}}{{P}_{Hist} - MF}$$

Steps 6-6 and 6-7 in the flowchart show the final calculations to render a forecast yield potential (YP) in accordance with this embodiment of the method. The total available moisture (M_{Total}) would be calculated by the forecasting software component using the formula:

M_{Total}=((W_{Raw}−WP)+P_{R}+P_{F})−MF

and finally the yield potential (YP) would be calculated using the formula:

YP=M_{Total}*F_{UE}

Following the completion of calculation of the yield potential (YP), this particular embodiment would display the calculated result to a user via a user display of the computer, shown at Step 6-8.

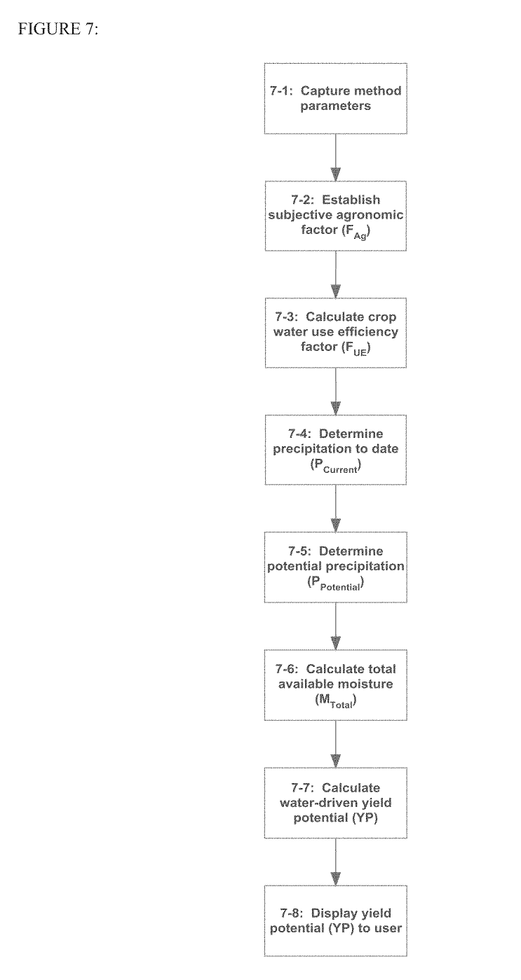

An alternate embodiment of the single calculation approach is shown in FIG. 7—the difference in the method demonstrated in FIG. 7 is that the method includes the use of a subjective agronomic factor to alter the forecast yield potential (YP) results. In such an embodiment of the method, the capture of method parameters at 7-1 could include the direct data entry of the subjective agronomic factor (F_{Ag}) to be used, or the user interface could provide the ability for the user to select or specify at least one additional agronomic variable which it was desired to use to alter crop water usage in the calculations. The confirmation or establishment of the subjective agronomic factor (F_{Ag}) is shown at step 7-2.

Beyond the establishment and use of a subjective agronomic factor (F_{Ag}), the remainder of the embodiment of the method outlined in FIG. 7 is similar to that of FIG. 6. Steps 7-3 through 7-6 show the calculation of the various variables used in the eventual rendering of a water driven yield potential (YP) calculation. The calculation of the water driven yield potential (YP) is shown at 7-7 and is similar to that shown in the parallel step of FIG. 6 except that the actual formula used for the rendering in this embodiment is as follows, reflecting the subjective agronomic factor:

YP=M_{Total}*F_{UE}8F_{Ag}

As outlined it is explicitly contemplated that the way that the subjective agronomic factor (F_{Ag}) might most easily be reflected in calculations in accordance with the remainder of the method of the present invention would be to stipulate that the subjective agronomic factor (F_{Ag}) was a multiplier applied to the formula, with a default value of 1. If it was desired to apply agronomic variables that resulted in the higher use of water, reflecting a potential lowering of the yield potential (YP), the multiplier could be lowered into the range between zero and one, and if it was desired to provide a yield potential boost in the calculation i.e. less water was required, the multiplier could be increased above one. It will however be understood that there will be other ways applying or determining a subjective agronomic factor (F_{Ag}) as well—a multiplier or other type of mathematical function could be used and any type of a mathematical modification which could be codified in the forecasting software component for the purpose of applying multiple additional agronomic variables to the calculations rendered in accordance with the remainder of the method of the present invention will be understood to be contemplated within the scope hereof.

Illustrative Environment and System Architecture:

The software method of the present invention can be practised via locally installed software on a local computer, or in other embodiments could be offered via a client/server or wide area network embodiment. We will now quickly demonstrate an illustrative architecture which could be used to offer the various embodiments of the method of the present invention, before going on to explain further method variations.

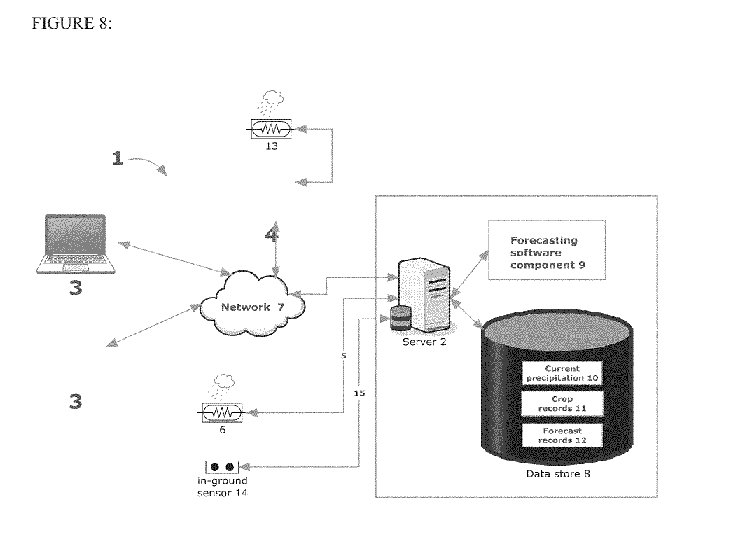

FIG. 8 shows an illustrative architecture of an overall computer system 1 in accordance with the present invention. The particular architecture shown in this Figure is a client/server system, the server being the computer 2 which will host the data and software to administer the method, and a plurality of client devices 3 capable of communicating with the computer 2 for the purpose of user interaction. As outlined elsewhere herein and below, it is explicitly contemplated that this type of a system in accordance with the method of the present invention could be a website system, although a proprietary communication and software system could also be used in both such approaches will be understood to be within the scope of the present invention.

The server 2 is a computer capable of communication with other components via a network interface, as well as posting or being accessible to a forecasting software component 9 which is the software which will administer the method of the present invention as well the data store 8 that contains in the Figure is shown a plurality of datasets relevant for these purposes. The data store 8 as shown demonstrates the current precipitation data source 10, a plurality of crop records 11 and a plurality of yield potential records 12. The server 2 is shown connected to an external network 7 by which additional devices may communicate therewith. For example, two client devices 3 which would potentially be the interfaces by which users would participate in the execution of the method of the present invention are shown.

The historical precipitation data source computer 4 is shown in turn connected to a precipitation sensor 13. The sensor 13 might be a site proximate precipitation sensor, or else the historical precipitation data set contained within the computer 4 may aggregate weather information from other networks etc. It will be understood that any type of a dataset which contains historical precipitation data of sufficient particularity, granularity in proximity to the field sites in question will be within the intended scope of this element of the invention.

Also shown connected to the server 2 is a current precipitation sensor 6 connected via a network communications bus 5. The current precipitation sensor 6 could capture precipitation data at or near the growing site for the crop being monitored, for logging of such information into the current precipitation dataset 10 for use in accordance with the remainder of the present invention. Again as is outlined elsewhere herein with respect to this aspect of the method as well as the historical precipitation data source, the current precipitation dataset 10 might be populated by data captured by a local precipitation sensor or data source 6, or via replacing the current precipitation data sensor 6 with access for example to a third-party weather service or some other means of obtaining locally relevant and site proximate precipitation data.

Also shown in this particular Figure is an in-ground sensor 14 which could be used to capture the current precipitation readings within the field site at any particular chosen time, within the rooting depth. The sensor 14 is shown in communication with the server 2 via a communications bus shown at 15.

Multiple types of in-ground moisture sensors could be used to facilitate the method of the present invention. As outlined throughout this application, it is explicitly contemplated that inground moisture sensors capable of reading from a single depth within the rooting depth of a field site, or other inground moisture sensors which will permit the acquisition of multiple steps readings within the rooting depth of the field site are both contemplated within the scope of the present invention. In embodiments of the method of the present invention in which it is desired to increase the accuracy and granularity of the method by using readings from multiple depths within the rooting depth of the field site, either a single multi-depth sensor or multiple single depth sensors could be used. Both such approaches are contemplated within the present invention.

Dependent upon the remainder of the architecture of the system being used to administer the method, the server 2 might communicate directly with the inground sensor 14 via a wired or wireless connection, or in other cases the sensor 14 might provide remote information to the network interface of the server 2 via an API or the like to a third-party provider. For example it is explicitly contemplated that the system and method of the present invention could be used by agronomist or a farmer to conduct yield potential forecasting with respect to their crops and use either current soil sample or soil moisture readings or even current precipitation readings from a third-party service who could be a service provided to the farmer for other purposes—for example other companies may provide to the farmer access to the necessary sensing technology for use in multiple applications on a farm and it is explicitly contemplated and will be obvious to those skilled in the art of network communications and system design that accessing remotely hosted or acquired inground moisture readings or the like from a remote data source for use by the server 2 in the administration of the method of the present invention is contemplated within the scope hereof.

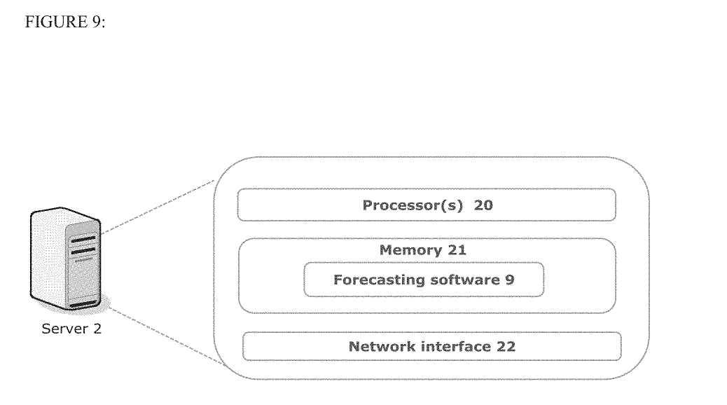

FIG. 9 outlines an illustrative embodiment of a computer 2 in accordance with the present invention. The computer 2 as shown comprises one or more processors 20 and memory 21. The memory 21 might contain various software components or a series of processor instructions for use in the method of the present invention or otherwise in the operation of the computer 2. Processor instructions corresponding to the forecasting software component 9 are shown stored within the memory 21. The forecasting software component 9 would administer the method of the present invention, accessing data within the data store 8 and the necessary sensor readings captured from the inground sensor 14, the current precipitation sensor 6 and the historical data source 4 as shown. The forecasting software component 9 might act as the interface between the remainder of the hardware and software of the computer 2 and the data store 8, or the computer 2 might alternatively include additional software interface components to allow for communication with the data store 8 and the databases contained therein.

The embodiment shown in these Figures includes a crop database 11 in the yield potential database 12 within the data store 8. This particular type of an embodiment of the system 1 could be used in a graphical forecasting or historical data view approach, whereas in some simpler embodiments locally installed forecasting software components 9 could be installed on local computers for local use by a single user. Both such approaches are contemplated within the scope of the present invention. The forecasting software component 9 would comprise subroutines for the administration of the current precipitation data source 10 if locally hosted, the crop database 11 and the yield potential database 12. Additionally, the software component would facilitate the execution of user interface transactions with user devices, as well as executing searches and reporting against the data store 8 as might be required. Finally and most importantly, the forecasting software component 9 would also execute the mathematical operations for the calculation of the crop water use efficiency factor, the available total moisture and the water-driven yield potential in the forecasting method.

Also shown in this Figure is the network interface 22. The network interface 22 would comprise the necessary hardware and software components resident on or installed upon the computer 2 which would allow the computer 2 to communicate with user devices, remote data sources and any other networked components in the facilitation of the method. The network interface 22 could be any wired or wireless interface using a network protocol allowing the computer 2 to communicate with the necessary devices over a wide or local area.

The variations and the details of the user displays of client devices or computer interfaces which might be used in accordance with the present invention are as varied as the number of devices available. However, the general concept of a user display or user interface for the computer 2, or a client device in a client/server embodiment of the system of the present invention, would be the provision of a display such as a monitor or electronic visual display, coupled with the potential input device is operatively connected to the computer 2 the client device to allow a user to interact with the remainder of the system of the present invention—a keyboard, mouse, visual screen interface or otherwise.

Forecasting Software Component:

The details of the required computer processor instructions required in the forecasting software component 9 to permit the conduct of the method as outlined herein will be understood to those skilled in the art of database design and computer software programming and any type of an approach that yields computer software executable upon computer capable of executing the steps of the method of the present invention is contemplated within the scope hereof. In addition to the method outlined herein it is explicitly contemplated that the invention as claimed also encompasses a non-transitory computer-readable storage medium for use in a method of estimating yield potential within a current growing season for a selected crop planted at a field site, the computer-readable storage medium including instructions that when executed by a computer cause the computer to execute any series of steps equating to the methods outlined above and described in reference to the claims and embodiments outlined herein. The remainder of the variations, parameters and embodiments of the method of the present invention outlined elsewhere herein could all be achieved using the non-transitory computer readable storage medium and software stored thereon.

Historical Precipitation Data Source:

The historical precipitation data source is any readable dataset which can be used by the computer in association with the remainder of the method of the present invention to assess precipitation on a daily basis, for the purpose of calculating comparatively the aggregate amounts of precipitation which have been historically available to crops at the selected field site, for use in association with the remainder of the present invention. In the system embodiment shown in FIG. 8, the historical data source 4 is a remote network-connected computer and containing the necessary historical precipitation information. It is particularly contemplated that from a historical perspective the dataset and the data source used might be publicly available whether dataset in which precipitation information may be contained. Farmers might also have their own historical datasets which they capture with relation to their specific field sites, and both such approaches are contemplated within the scope of the present invention. By using a historical precipitation data source that contains calendar correlated precipitation data, day by day plant-available water calculations that historical dates can be used if desired to do so. The historical precipitation data source would likely contain precipitation data from at least one precipitation sensor proximate to the field site. Precipitation data might be environmental rain data captured from a rain sensor, or other types of locally captured data or sensor readings which can be used to determine precipitation received. Any type of a sensor and a historical precipitation data source which contains the necessary information to on a date basis ascertain precipitation received at the field site, which can be combined with other method parameters to determine plant-available water in that particular historical date, will be useful and are contemplated within the context and extent or scope of the present invention.

The historical precipitation data source could contain data from more than one previous growing season and if that were the case, the data from multiple previous historical growing seasons at the field site could be averaged or otherwise formatted or transformed for use in accordance with the remainder of the present invention. The historical precipitation data source is explicitly contemplated in software embodied approaches to the invention a network data source readable by a computer. The historical precipitation data source could be a locally hosted dataset on a local computer executing software to run the forecasting scenarios of the present invention or could be a remote or even third-party provided dataset which was operably connected to a computer executing software to run the forecasting scenarios.

Current Precipitation Data Source:

The current precipitation data source is any readable dataset which can be used by a computer in association with the remainder of the method of the present invention to assess precipitation and plant-available water on a daily basis, for the purpose of calculating comparatively the aggregate amounts of plant-available water which have been available to the selected crop at the field site within the current growing season. In the system embodiment shown in FIG. 8, the current precipitation data source 10 is a locally hosted dataset containing the necessary current season precipitation information, which would be captured via the interface 15 from the inground sensor 14. The current growing season precipitation data source 10 might also be a remote or third-party service if the remote or third-party service has access to sensor data of particular geographic relevance.

Using a calendar correlated current precipitation data source 10 provides day by day plant-available water capability which can be used to an aggregate calculate the plant-available water in the growing season to date. Based on locally captured precipitation information or remotely maintained locally captured information, any type of a sensor and current precipitation data source 10 which contains the necessary information to on a date basis calculate the precipitation received at the field site along with determining the plant-available water by applying the other method parameters thereto is contemplated within the scope of the present invention. The current precipitation data source 10 as shown in FIG. 6 is a locally hosted software dataset. Remotely hosted information accessible to the computer 2 via a network interface is also contemplated to be within the scope of the present invention.

Crop Database:

The operability of the method and the computer-based embodiments of the invention, relying in part upon a crop database 11 comprising a plurality of crop records 31 will be understood to those skilled in the art and any approach accomplishing this objective will be understood to be within the scope of the present invention. The crop database 11 might be resident on the computer 2, or might alternatively be resident on or administered remotely within a network connected server from the database environment which is operatively connected for communication with the computer 2 the remainder of the system of the present invention. The crop database 11 might also comprise multiple databases or files rather than a single database file structure.

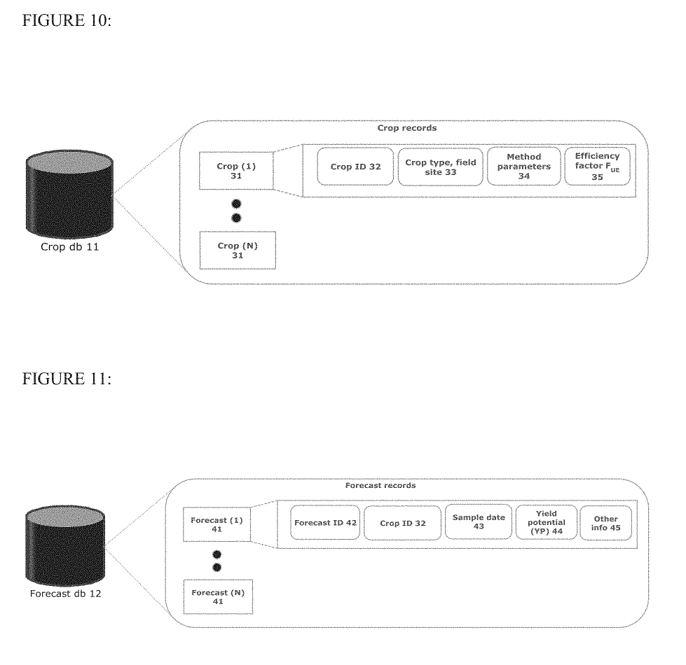

Referring to FIGS. 8 and 10 there is shown a schematic diagram of one potential data structure of a crop database 11 in accordance with the remainder of the present invention.

The Figure presented shows a relational database structure—flat file structures on other types of data frameworks could all be used to store information such as this without departing from the scope of the present invention. The crop database 11 comprises a plurality of crop records 31. Each crop record 31 contains the necessary information to administer the yield potential forecasting method of the present invention in respect of a particular crop. One element of the typical database crop record 31 would be a record key or a crop identifier 32. In addition, two of the additional data tokens which could be stored and maintained would be the crop type and the field site particulars for the crop in question, shown at 33. In addition to the crop type and field site 33, method parameters 34 defined for executing the forecasting methodology of the present invention in respect of a particular crop and field site pairing will be stored. These method parameters 34 are expected to comprise at the least, the planting date and the completion date defining the current growing season and a calculation date of the calculation; the raw water value; and any additional agronomic variables which would alter crop water usage. The method parameters stored might also optionally include the historical seasonal precipitation for at least one historical growing season based on the planting date and the completion date, from data stored within the historical precipitation data source, so that information on a seasonal basis was easily available the remainder of the mathematical modelling components of the forecasting software. Alternatively, this type of information could be accessed from the historical precipitation data source as required.

The final element stored in the crop record 31 as shown in this embodiment is the actual crop water use efficiency factor 35. The crop water use efficiency factor 35 will be stored in a format that results in the ability for the forecasting software component to as required apply the mathematical crop water use efficiency factor 35 to newly derived current total precipitation figures to provide current forecast results. The exact formatting of the crop water use efficiency factor 35 or the means of storage will depend to a degree upon the nature of the mathematic modelling engine contained within the formatting software component.

Each crop record 31 might also include other additional types of information which could be used in the execution of the present invention—other record-keeping information, data fields used for reporting purposes, statistics and the like could also be tracked and maintained in respect of a crop record 31 either within the same record in the crop database 11, or in other related tables. The particular construction or data structure of the crop database 11 might also depend on the infrastructure side of the remainder of the system the present invention—it is specifically contemplated that the crop database 11 will most likely comprise an SQL database, however other approaches, tools and development environments could also be used.

The system embodiment in FIG. 8 demonstrably illustrates the crop database 11, the yield potential database 12, and the current precipitation data source 10 all being resident in a single locally administered data store 8. It will be understood that separate data structures for each of these datasets, or even some of them being locally hosted on the computer 2 is being accessible via a local or wide area network connection are all contemplated as approaches which could be within the scope intended.

Yield Potential Database:

In some embodiments of the system and method of the present invention a yield potential database such as that shown in FIGS. 8 and 11 might be used to retain historical calculation results in accordance with the remainder of the method of the present invention which could be used for the purpose of plotting performance or results over the course of the current growing season. The yield potential database 12 as shown is comprised of a plurality of yield potential records 41. Each yield potential record 41 contains the results of a calculation executed in accordance with the present invention. There is shown a record identifier or a database key 42, along with a link to a crop record 31 in the crop database 11. The calculation date 43 of the forecast calculation is also shown, along with the calculated yield potential 44. The yield potential record 41 might also include additional information in respect of the calculation itself—for example, the other information 45 which would be retained might include details of the method parameters used to execute the calculation etc., such that when the information contained in the yield potential record 41 was used in subsequent calculations, the necessary additional method parameters used in the forecast scenario or forecast transaction executed which yielded the results memorialized in that particular yield potential record 41 can also be accessed or used.

The yield potential database 12 might be resident on the computer 2, or might alternatively be resident on or administered remotely within a network connected server from the database environment which is operatively connected for communication with the computer 2 the remainder of the system of the present invention. The yield potential database 12 might also comprise multiple databases or files rather than a single database file structure. The particular construction or data structure of the yield potential database 12 might also depend on the infrastructure of the system the present invention, similar to the crop database 11 outlined in further detail above.

Multi-Crop Forecasting Method:

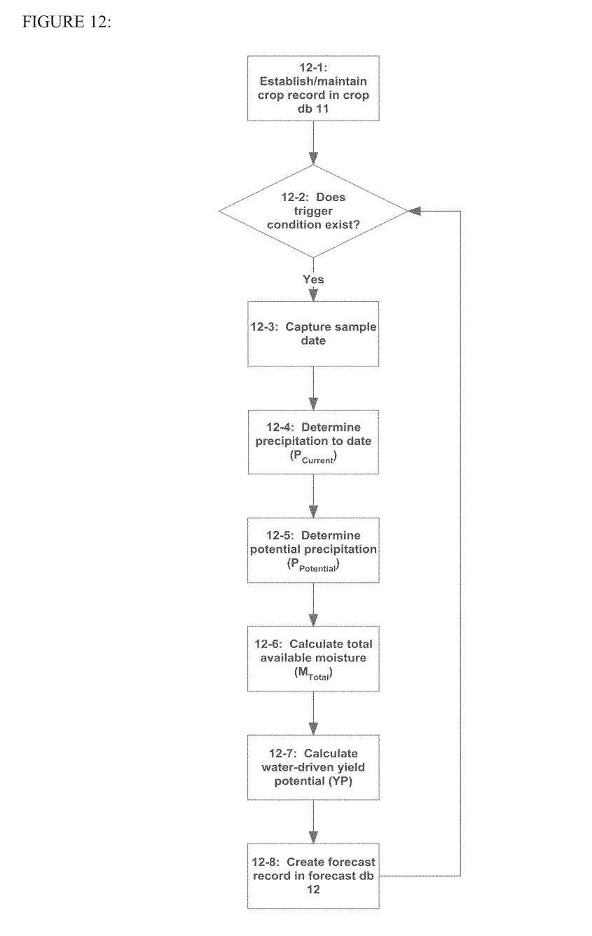

In addition to the embodiments of the method of the present invention outlined above, it is also specifically contemplated that the method of the present invention could be implemented in a way that would allow for the monitoring of multiple crop and field site combinations for multiple producers using a single physical system and forecasting software component, with the necessary and appropriate, and understood in the art, security framework and design. A first example of the multi-crop forecasting method contemplated is shown in the flowchart of FIG. 12. The method of FIG. 12 would be practised using architecture and software in accordance with that demonstrated and described above with reference to FIGS. 8 through 11.

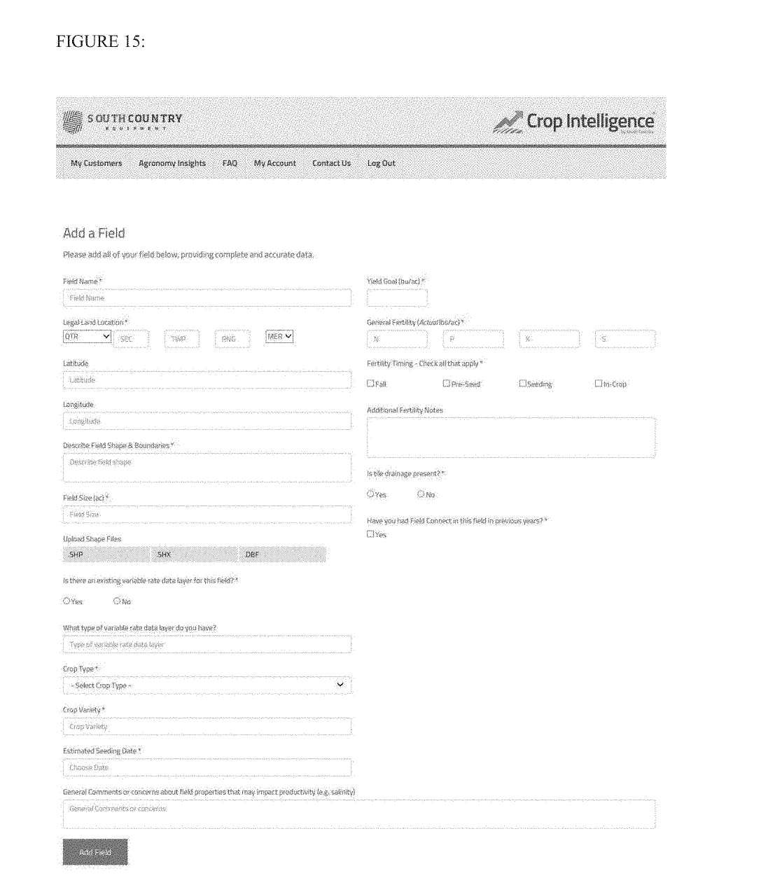

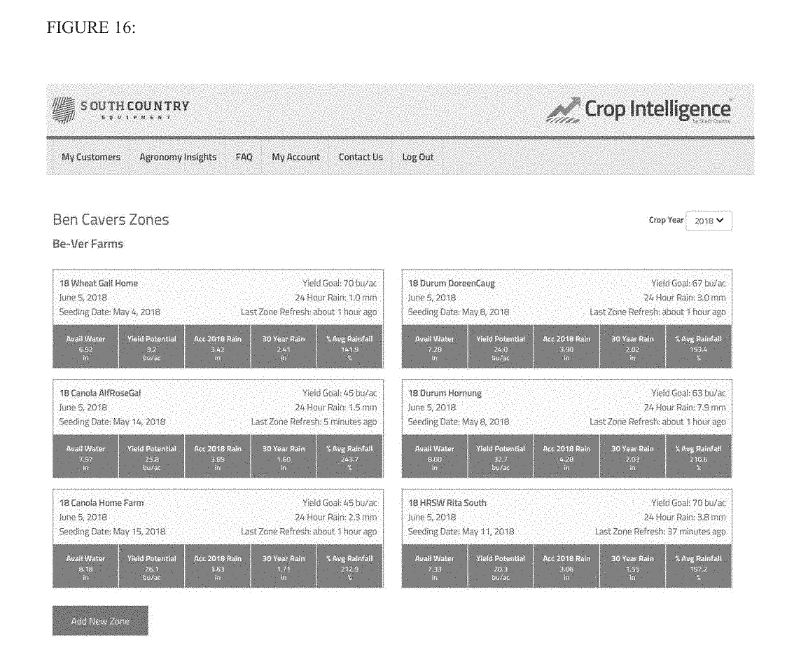

In the embodiment of the method shown in FIG. 12, the first step which is shown is the establishment or updating as required of a crop record in the crop database 11. This is shown at step 12-1. The user interface or client interface operatively connected to the server or computer 2 of the present system could allow for the entry or updating of information for storage and to one or more crop records within the crop database 11. FIG. 15 is a sample of a screenshot of one user interface which could be used to capture desirable information and method parameters for storage in a crop record in the crop database and all 11. In this step, the necessary method parameters 34 would be captured with respect to the particular crop and field site combination in question. As outlined elsewhere throughout this document, the key method parameters 34 in respect of a crop record which would be stored include:
1. the planting date and the completion date of the current growing season;
2. any additional agronomic variables which would alter crop water usage; and
3. a crop water use efficiency factor (F_{UE}) for the selected crop at the field site calculated in accordance with the methodology and formula outlined elsewhere herein.

Additional agronomic variables could be selected from the group of field stresses for the field site; soil test values for the field site; planned fertilizer application rates for the field site; the planned timing for fertilizer application within the current growing season; details of planned chemical applications at the field site; and specific growing characteristics of the selected crop.

The crop records within the crop database 11 might also include the calculated or entered values for

In addition to the crop database 11 comprised of a plurality of crop records representing particular crop and field site combinations, the system of the present invention in this embodiment would also incorporate a yield potential database as discussed herein as well.

The crop record establishment or maintenance step, shown at 12-1, is a configuration of database maintenance task—the primary calculation method would rely upon established crop records in a crop database 11, so it will be understood to those skilled in the art of programming and database design that the actual setup step for the database records in the crop database or the yield potential database while required for the practice of the method could be executed in many different ways and in its broadest sense the water driven yield potential calculation method of the present invention relies upon records which are already established, rather than records required to be established in the independent and broadest sense of the method.

The method of FIG. 12 shows a monitoring loop—the forecasting software component 9 on the computer 2 would monitor the crop records within the crop database 11 and other environmental parameters to ascertain the existence of a trigger condition or step, which is effectively the existence of a condition upon which a yield potential forecasting calculation in accordance with the method of the present invention should be executed—the trigger condition might be the arrival of a particular preprogrammed and periodic time period, selection of a manual trigger by a user of a client device operatively connected to the computer 2, or any number of other types of conditional programming which could be used in terms of the existence of a trigger condition. The monitoring block in the flowchart for the testing for the existence of a trigger condition is shown at 12-2.

If a trigger condition does exist, such that a yield potential calculation needs to be conducted or administered, the forecasting software component 9 would capture a calculation date in reference to a particular crop record in the crop database 11. Capture of the calculation date is shown at step 12-3. Based upon the planting date and the growing season parameters stored within the related crop record, the forecasting software component would then determine the precipitation received within the current growing season (P_{R}) at the field site from the planting date to the calculation date, based on data stored within a current precipitation data source containing daily actual precipitation amounts for the field site for each calendar day of the current growing season—shown at 12-4.

In addition to the calculation or determination of precipitation received within the growing season (P_{R}), the forecasting software component 9 would also determine the forecast precipitation for the remainder of the current growing season (P_{F}) at the field site from the calculation date to the completion date—shown at 12-5.

Following the determination of the precipitation received and the forecast precipitation in the remainder of the current growing season, shown at 12-6, the forecasting software component 9 would next calculate the total available moisture (M_{Total}) using the formula:

M_{Total}=((W_{Raw}−WP)+P_{R}+P_{F})−MF

In addition to or following the calculation of the total available moisture (M_{Total}), step 12-7 shows the calculation of the water-driven yield potential (YP), in accordance with the formulae outlined throughout:

YP=M_{Total}*F_{UE}

Following completion of the calculations outlined above, the forecasting software component 9 would create a related yield potential record in the yield potential database, linked to the related crop record and storing the yield potential (YP) along with the other record contents (shown at 12-8). On completion of creation of the yield potential record, the monitoring loop for detection of trigger conditions in relation to one or more of the crop records in the crop database 11 would continue.

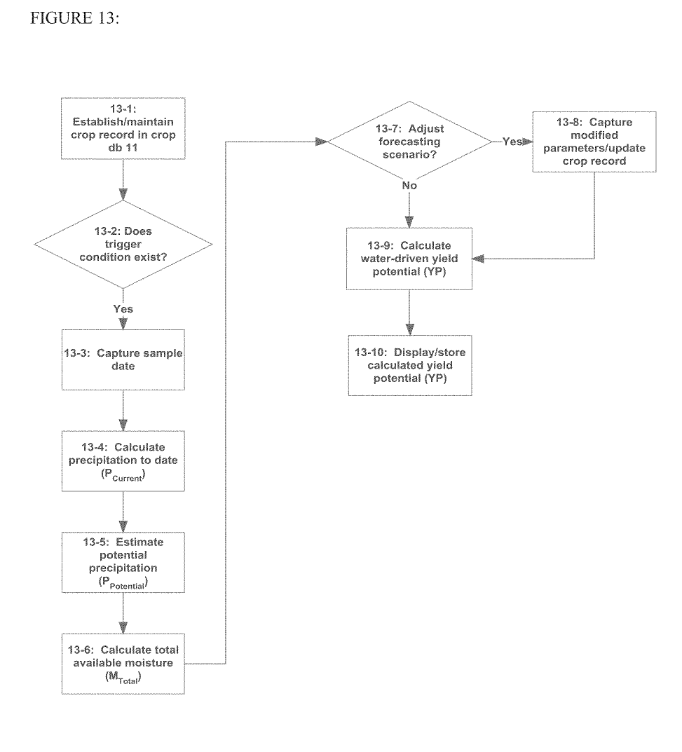

FIG. 13 is a flowchart demonstrating the steps of a second embodiment of the software method of the present invention, demonstrating some further flexibility. Crop records can be established, adjusted or maintained in the crop database 11—shown at step 13-1. The existence of a trigger condition for the execution of the forecast in accordance with the present invention could be determined by the listener or decision step shown at 13-2 on the detection of a trigger condition, the calculation could be commenced—again starting with the capture of the calculation date in respect of which the forecast should be conducted (Step 13-3), calculation and estimation of precipitation received (P_{R}) and forecast precipitation (P_{F}) (Steps 13-4 and 13-5), and the calculation of total available soil moisture (M_{Total}) (Step 13-6).

The embodiment of FIG. 13 allows for the adjustment of the forecasting scenario—a second listener or decision step is shown at step 13-7—where the user indicates a desire via the computer user interface to alter the forecasting scenario being executed, or even in the case of programmable logic requiring an adjustment to one or more parameters stored in relation to the crop record so that the forecasting transaction can be completed, modified parameters can be captured from a user interface and or the crop database 11 updated—shown at 13-8. Either in the case of the completion of the update to the crop database and crop record, or in the case of no required adjustment to the forecasting scenario, the crop water use efficiency factor (F_{UE}) can be applied to yield the forecast crop yield potential (YP) based on the plant-available water at the field site to the selected crop in the current growing season (Step 13-9) and either displayed to the user or stored to the yield potential record in the yield potential database 12 (Step 13-10). The formulae used for the various calculations outlined re discussed in detail elsewhere herein.

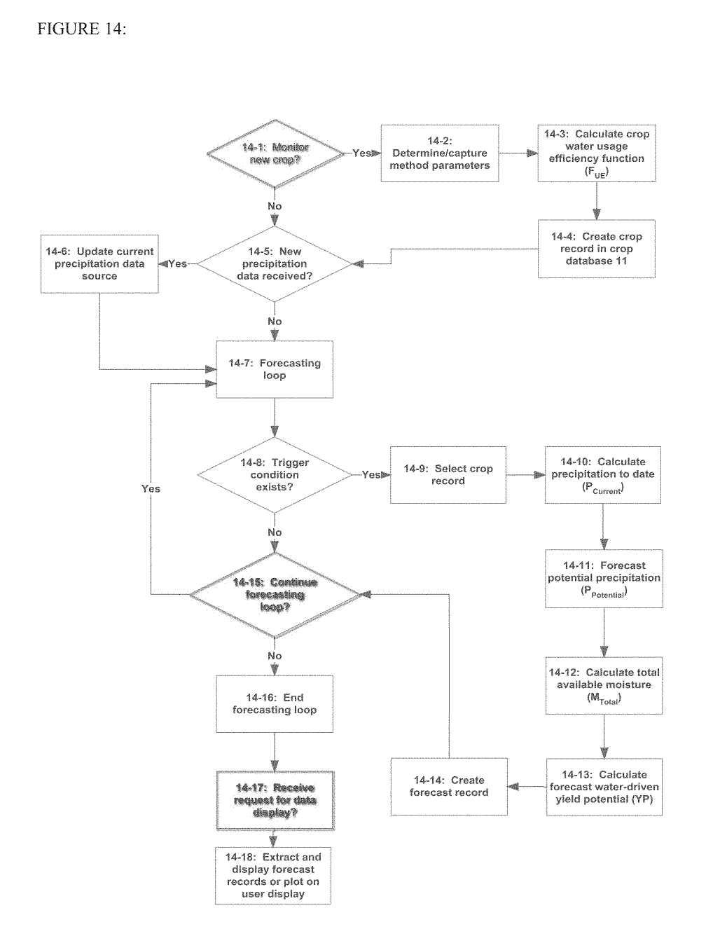

FIG. 14 is another flowchart demonstrating multiple steps in a further embodiment of the method of the present invention, conducted again by a forecasting software component 9. The forecasting software component 9 via the computer 2 could facilitate a user interface whereby a user could indicate to the computer 2 a desire to create a new crop record in the crop database 11 to commence the monitoring in accordance with the remainder of the method of the present invention of a new combination of a selected crop at the field site for a current growing season. This step in the method is shown via the listener or decision block shown at 14-1. As shown, on the yes leg at 14-2, where a user would indicate to the computer 2 a desire to create a new crop record, the user interface of the client device or the computer 2 could also permit the entry or capture of the method parameters required for storage in the crop record. Following the capture of the first series of method parameters, including the date parameters of the desired growing season, the historical growth season precipitation could be collected or calculated from the historical precipitation data source 4, shown at 14-3. This could also include the determination of the actual plant-available water throughout the entirety of the historical comparative growing season, by applying the method parameters, additional agronomic variables, soil texture and other additional agronomic variables to the historical growth season precipitation calculation. Shown next at 14-4 is the establishment of the crop water use efficiency factor (F_{UE}). Finally, the crop water use efficiency factor (F_{UE}) and the remainder of the method parameters etc. would be stored to a crop record crop database 11, shown at 14-5.

Either the computer 2 in conjunction with the forecasting software component 9 or a third party precipitation information provider, could also capture and catalogue new precipitation data from the field site. Shown at 14-6 is another decision block—where new precipitation data was received by the computer, for example via the current precipitation sensor 6, the current precipitation data source 10 maintained within the data store 8 could be updated with that additional current precipitation data. As outlined in further detail elsewhere herein it is contemplated that the current precipitation data source 10, by capturing record of any significant precipitation received at the field site, could develop a date related data table indicating dates within the current growing season upon which precipitation was received at the field site in addition to the amount of precipitation received.

In addition to providing user options for updating or creation of new crop records and the crop database, as well as the capture and maintenance of current growing season precipitation data to the current growing season precipitation data source 10, the next aspect of the method of the present invention shown in this Figure is an actual forecasting loop, shown between steps 14-8 and 14-19. As shown at step 14-8, if it is determined that a trigger condition exists namely that the condition exists for the execution of the forecasting transaction or computation in accordance with the remainder of the method of the present invention, the Yes leg of that decision is followed at 14-9 et al. Alternatively, if no trigger condition exists, the monitoring loop could continue unless or until it might be determined that a condition exists at which point the forecasting loop should be ended (Step 14-19).

If a trigger condition is determined to exist in respect of a crop record, the related crop record from the crop database 11 would be selected at 14-10 (the crop records in the crop database 11 might each have different trigger conditions defined with respect thereto as so there might be different types of trigger condition is detected in respect of different selected crop and field location combinations). The crop record would be selected, so that the related method parameters and crop water use efficiency factor (F_{UE}) stored in relation thereto could be accessed. The current season precipitation received would be calculated, along with a forecast of anticipated forecast precipitation for the season. Calculation of the current season precipitation received as well as the estimation of current forecast precipitation is shown at step 14-11.

Total available moisture (M_{Total}) for the crop is shown being calculated at 14-12, along with yield potential (YP) at 14-13. Finally, in the embodiment shown similar to that of FIG. 13, a yield potential record is created within the yield potential database 12, storing the calculation results and desirable interim inputs or variables for future reporting or use. As will be understood to those skilled in the art of database programming such as this, once the yield potential database 12 is captured, displays, reports and queries can all be run on the data stored therein on an ad hoc basis—for example step 14-20 shows the receipt of a request for a data display by the computer 2 and the forecast software component 9 from a client device—in which case the requested data can be extracted and displayed, or even plotted where it was desired to provide a graphic plot of the results of multiple yield potential records within a particular current growing season for the crop and field combination.

The embodiment of FIG. 14 is likely an embodiment in which the forecasting loop would trigger a frequency-based periodic execution of a forecast in accordance with the invention such that for example a daily, hourly, weekly or some other forecast frequency of records would be captured and could be plotted on an ongoing basis should be required or desired by the user. There could also be a manual trigger condition whereby a user would simply request the same via a client device 3 in communication with the server/computer 2. Any type of a trigger condition is understood to be within the intended scope of the present invention.

### Adjusting Forecast Scenarios:

For agronomists and farmers currently trying to forecast or adjust their farming practices based upon precipitation and plant-available water characteristics, any modification to the forecasting or scenarios executed by the agronomist or the farmer typically involves the manual application of a significant mathematical component. Providing a better ability to streamline precipitation based forecasting with respect to cropping practices, and particularly a method that relied upon plant-available water calculations, rather than just available precipitation numbers, as outlined herein, will provide a significantly advanced and enhanced tool over that presently available.

One of the specific elements and benefits of the invention is that particularly when embodied in a computer software delivery, the system and method of the present invention could be used to forecast different types of growing scenarios—for example, changing the available water or changing certain of the cropping characteristics and parameters. Providing a computer-based interface, via which one or more of the elements of the crop water use efficiency factor could be altered without the need to have the user understand the math behind the functionality and just allowing them to alter the inputs to the function and view or assess the yield a result is explicitly contemplated as a significant economic benefit of the present invention.

Provision of an interface based ability to adjust the parameters of forecasts executed in accordance with the remainder of the present invention will be understood to those skilled in the art of user interface design for computer software and the like, and any type of a system which allowed for modification or forecasting use of the system and method of the present invention to assess the impact on crop yield potential by alteration of various precipitation or other related characteristics to the method outlined herein is contemplated within the scope of the present invention.

Graphical Plotting and User Display:

One of the benefits of user interface design technology that is available in computer software at the present time is the ability to provide very useful business-oriented dashboards and the like—it is specifically contemplated that the system of the present invention could incorporate a graphical user interface which would allow for example plot the results of periodically executed forecasting calculations in accordance with the remainder of the present invention.

FIG. 15 is a representative sample of a dashboard screenshot which shows the current yield potential calculation results in accordance with the method of the present invention for a number of crops of a producer. The flexibility and variations available in the creation of these types of dashboards using the underlying calculated and stored data points of the method of the present invention will be understood to those skilled in the art of database reporting and user interface design and any type of a user display displaying the results of the present calculation method—statically, dynamically or interactively—will be understood to be within the scope of the present invention.

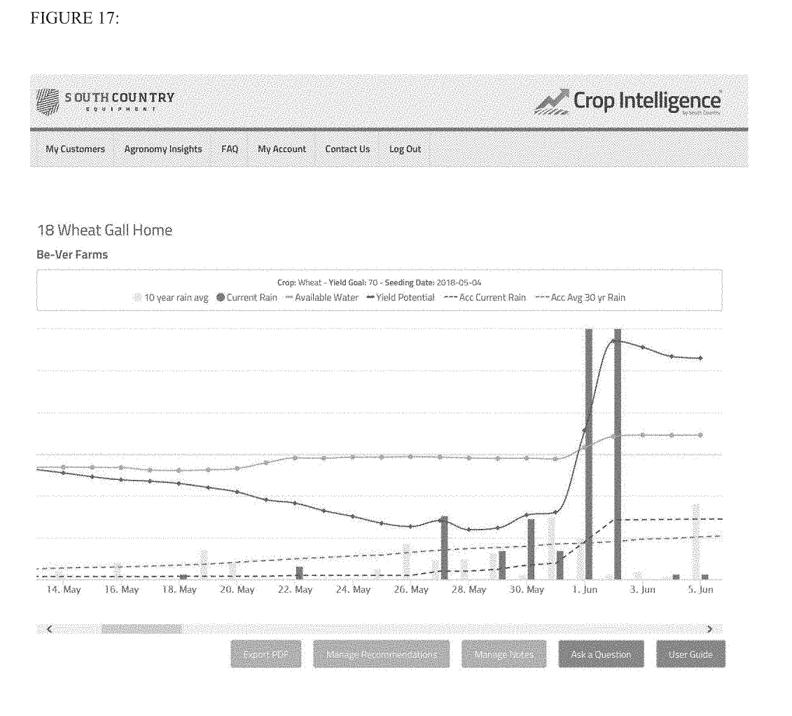

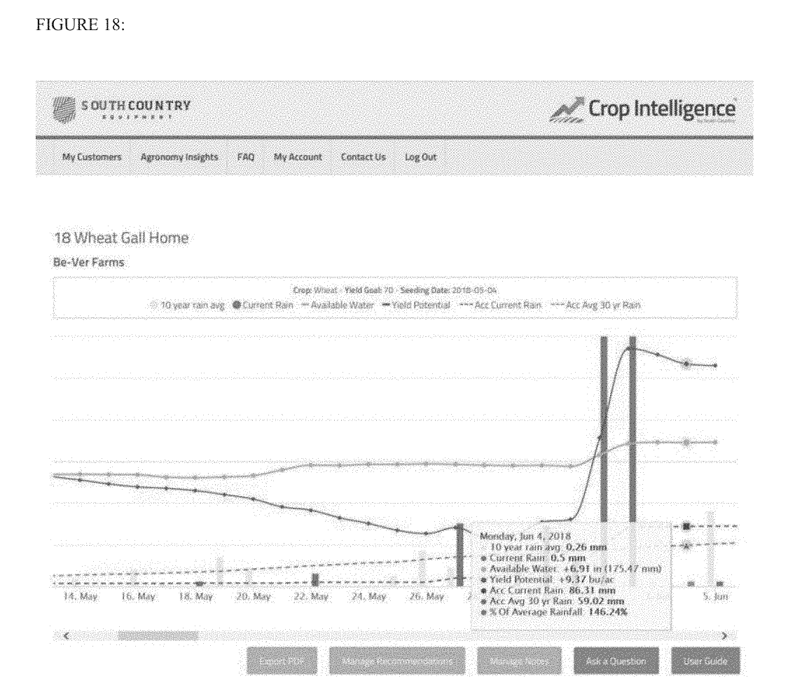

It will be understood that any type of a user interface incorporated into a software system in accordance with the remainder of the present invention which permitted for the graphical plotting of either chronologically oriented formulaic inputs to the crop water use efficiency factor, or outputs of the function, will all be contemplated within the scope of the present invention is they will be obvious to those skilled in the art of software design and capable of execution herein. FIGS. 17 and 18 are samples of either screenshots or printed reports which could be provided by various computerized embodiments of the software of the present invention, demonstrating the graphing of various relevant information from the process for use and forecasting crop outcomes and yield potential and tracking the yield potential for crop throughout the course of the current growing season as precipitation figures are captured on calendar dates throughout the season—the granularity of this available information can be appreciated by viewing it in this graphical form. A graphical format such as this would also be very useful for producers to review and to make in-season cropping adjustments—fertilizer, irrigation or the like, to the extent possible, where it was desired to adjust or impact the likely forecast yield potential (YP). It will be understood that the content of these two Figures shows only a couple basic embodiments of the graphical display of information generated in accordance with the remainder of the method of the present invention, and it will be understood that any type of a graphical display demonstrating the results of calculations conducted in accordance with the method outlined herein are all contemplated within the scope of the present invention.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of estimating yield potential (YP) for a selected crop growing at a field site for a current growing season having a planting date and a completion date, said method comprising:
a. in a capture step conducted at a sample date, capturing at least one moisture reading in relation to a sample depth within a rooting depth of the field site;
b. in a calculation step:
i. using the at least one moisture reading captured in relation to the rooting depth and other necessary method parameters, calculating the raw soil water value (W_{Raw}) within the rooting depth, being the amount of plant-available water within the rooting depth at the sample date;
ii. calculating the total available moisture (M_{Total}) using the raw soil water value (W_{Raw}), the precipitation received (P_{R}) at the field site to date within the current growing season, and the forecast precipitation (P_{F}) at the field site for the remainder of the current growing season;
iii. calculating the yield potential (YP) for the crop in the growing season based on the total available moisture (M_{Total}).

2. The method of claim 1 wherein the moisture reading for a sample depth is determined using a manually extracted soil sample.

3. The method of claim 1 wherein the moisture reading for a sample depth is captured using at least one in-ground moisture sensor.

4. The method of claim 1 wherein the calculation step comprises:
a. determining at least the following method parameters in advance of the determination of the raw soil water value (W_{Raw}):
i. the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;
ii. an initial moisture factor (MF) for the selected crop, being the required amount of available water for the selected crop to establish initial crop growth;
iii. a historical yield (Y_{Hist}) for the selected crop; and
iv. a permanent wilting point (WP) of the field site, being the inferior limit of crop available water in the soil of the field site;
b. calculating the yield potential (YP) by:
i. calculating a crop water use efficiency factor (F_{UE}) using the formula:
$${F}_{UE} = \frac{{Y}_{Hist}}{{P}_{Hist} - MF}$$
ii. determining the precipitation received (P_{R}) at the field site from the planting date to the calculation date, based on data stored within a current precipitation data source containing daily actual precipitation amounts for the field site for each calendar day of the current growing season;
iii. determining the forecast precipitation (P_{F}) at the field site from the calculation date to the completion date;
iv. calculating the total available moisture (M_{Total}) using the formula:
M_{Total}=((W_{Raw}−WP)+P_{R}+P_{F})−MF
v. calculating the yield potential (YP) using the formula:
YP=M_{Total}*F_{UE}

5. The method of 4 wherein the forecast precipitation (P_{F}) is calculated from the corresponding calendar date range from the calculation date to the completion date in the historical precipitation data source.

6. The method of claim 4 wherein the forecast precipitation (P_{F}) is identified from future precipitation forecasts.

7. The method of claim 4 wherein the historical precipitation data source contains precipitation data from at least one precipitation sensor proximate to the field site.

8. The method of claim 4 wherein the historical precipitation data source contains precipitation data for more than one previous growing season and averages the multiple previous years precipitation readings for each date within the calendar year.

9. The method of claim 4 wherein the current precipitation data source comprises precipitation data from at least one precipitation sensor proximate to the field site.

10. The method of claim 4 wherein:
a. the method parameters further comprise a subjective agronomic factor (F_{Ag}), having a default value of 1, adjusted for any additional agronomic variables which would alter crop water usage in the current growing season; and
b. the yield potential (YP) is calculated using the modified formula:
YP=M_{Total}*F_{UE}*F_{Ag}

11. The method of claim 10 wherein the additional agronomic variables used to establish the subjective agronomic factor (F_{Ag}) are selected from the group of:
a. field stresses for the field site;
b. soil test values for the field site;
c. planned fertilizer application rates for the field site;
d. the planned timing for fertilizer application within the current growing season;
e. details of planned chemical applications at the field site; and
f. specific growing characteristics of the selected crop.

12. The method of claim 4 wherein the completion date is determined using the forecasted days to maturity for the crop.

13. The method of claim 4 wherein the completion date is adjusted during the growing season based on actual crop growth completion or other factors.

14. A method of establishing a crop water use efficiency factor (F_{UE}) which can be used to transform the total available moisture for a selected crop at a field site in a current growing season to a forecast yield potential within the current growing season, said method comprising:
a. determining at least the following method parameters:
i. the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;
ii. an initial moisture factor (MF) for the selected crop, being the required amount of available water for the selected crop to establish initial crop growth;
iii. a historical yield (Y_{Hist}) for the selected crop;
b. determining the crop water use efficiency factor (F_{UE}) using the formula:
$${F}_{UE} = \frac{{Y}_{Hist}}{{P}_{Hist} - MF}$$
whereby said crop water use efficiency factor can be used to forecast yield potential for a selected crop in a current growing season by multiplying the total available moisture for the current growing season with said crop water use efficiency factor.

15. The method of claim 14 wherein the method is executed by a computer software program on a computer.

16. A method of using a computer to estimate yield potential (YP) for a selected crop growing at a field site for a current growing season having a planting date and a completion date, wherein the computer comprises a forecasting software component within the memory of the computer capable of facilitating the necessary data transactions of the method and a user display via which the results of the method can be displayed to a user, the method comprising, by operation of the computer and the forecasting software component, executing the steps of:
a. using at least one moisture reading captured in relation to a capture depth within a rooting depth of the field site and other necessary method parameters, calculating the raw soil water value (W_{Raw}) within the rooting depth, being the amount of plant-available water within the rooting depth at the sample date;
b. calculating the yield potential (YP) for the crop in the growing season based on the combination of the total inseason precipitation and the raw soil water value, being the total seasonal plant-available water for the crop; and
c. displaying the calculated yield potential (YP) for the crop to a user of the computer.

17. The method of claim 16 wherein the moisture reading for a sample depth is determined using a manually extracted soil sample.

18. The method of claim 16 wherein the moisture reading for a sample depth is captured using at least one in-ground moisture sensor.

19. The method of claim 16 wherein:
a. the computer further comprises a user input interface to allow a user to provide to the computer for storage or use at least the following method parameters in respect of the selected crop and the field site in advance of the calculation of the raw soil water value (W_{Raw}):
i. a calculation date being the effective date of the estimate calculation;
ii. an initial moisture factor (MF) for the selected crop, being the required amount of available water for the selected crop to establish initial crop growth;
iii. a historical yield (Y_{Hist}) for the selected crop; and
iv. a permanent wilting point (WP) of the field site, being the inferior limit of crop available water in the soil of the field site;
b. calculation of the yield potential (YP) comprises:
i. determining the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;
ii. determining the precipitation received (P_{R}) at the field site from the planting date to the calculation date, based on data stored within a current precipitation data source containing daily actual precipitation amounts for the field site for each calendar day of the current growing season;
iii. determining the forecast precipitation (P_{F}) at the field site from the calculation date to the completion date;
iv. calculating a crop water use efficiency factor (F_{UE}) using the formula:
$${F}_{UE} = \frac{{Y}_{Hist}}{{P}_{Hist} - MF}$$
v. calculating the total available moisture (M_{Total}) using the formula:
M_{Total}=((W_{Raw}−WP)+P_{R}+P_{F})−MF
and
vi. calculating the yield potential (YP) using the formula:
YP=M_{Total}*F_{UE}

20. The method of claim 19 wherein the historical precipitation data source contains precipitation data from at least one precipitation sensor proximate to the field site.

21. The method of claim 19 wherein the historical precipitation data source contains precipitation data for more than one previous growing season and averages the multiple previous years precipitation readings for each date within the calendar year.

22. The method of claim 19 wherein the current precipitation data source comprises precipitation data from at least one precipitation sensor proximate to the field site.

23. The method of claim 19 wherein the computer further comprises a connection to the historical precipitation data source.

24. The method of claim 19 wherein the computer further comprises a connection to the current precipitation data source.

25. The method of claim 19 wherein the forecast precipitation (P_{F}) is calculated from the corresponding calendar date range from the calculation date to the completion date in the historical precipitation data source.

26. The method of claim 19 wherein the forecast precipitation (P_{F}) is identified from future precipitation forecasts.

27. The method of claim 19 wherein the yield potential (YP) is calculated using the modified formula:
YP=M_{Total}*F_{UE}*F_{Ag}
wherein F_{Ag} is a subjective agronomic factor, having a default value of 1, adjusted for any additional agronomic variables which would alter crop water usage in the current growing season; and
wherein the data capture step further comprises capturing the subjective agronomic factor (F_{Ag}) or the additional agronomic variables from which the subjective agronomic factor (F_{Ag}) can be determined for use in the remainder of the method.

28. The method of claim 27 wherein the additional agronomic variables used to establish the subjective agronomic factor (F_{Ag}) are selected from the group of:
a. field stresses for the field site;
b. soil test values for the field site;
c. planned fertilizer application rates for the field site;
d. the planned timing for fertilizer application within the current growing season;
e. details of planned chemical applications at the field site; and
f. specific growing characteristics of the selected crop.

29. A method of estimating yield potential (YP) for at least one selected crop growing at a field site for a current growing season having a planting date and a completion date, said method using a computer comprising:
a. a connection to a historical precipitation data source containing daily average precipitation amounts for the field site for each calendar day of at least one previous calendar year;
b. a connection to a current precipitation data source containing daily actual precipitation amounts for the field site for each calendar day of the current growing season;
c. a crop database comprising at least one crop record storing at least the following with respect to a selected crop planted at a field site:
i. the planting date and the completion date of the current growing season;
ii. any additional agronomic variables which would alter crop water usage; and
iii. a crop water use efficiency factor (F_{UE}) for the selected crop at the field site calculated using the formula:
$${F}_{UE} = \frac{{Y}_{Hist}}{{P}_{Hist} - MF}$$
where:
Y_{Hist} is a historical yield for the selected crop;
P_{Hist} is the historical seasonal precipitation, being the total of daily average precipitation amounts for a calendar date range defined by the planting date to the completion date of the current growing season, based on data stored within a historical precipitation data source containing daily average precipitation amounts for the field site for each calendar day of at least one previous growing season; and
MF is an initial moisture factor for the selected crop, being the required amount of available water for the selected crop to establish initial crop growth;
iv. the raw soil water value (W_{Raw}) within a rooting depth of the field site at the planting date based on at least one moisture reading captured in relation to a sample depth within the rooting depth; and
v. a permanent wilting point (WP) of the rooting depth, being the inferior limit of crop available water in the soil of the field site;
d. a yield potential database comprising at least one yield potential record corresponding to a calculation executed in accordance with the method, each yield potential record containing at least:
i. a link to a related crop record;
ii. a calculation date; and
iii. the yield potential (YP) of the selected crop in the current growing season as of the calculation date; and
e. a forecasting software component capable of facilitating the necessary data transactions of the method;
the method comprising using the forecasting software component to execute a yield potential calculation by:
a. in a trigger step, upon the detection of a trigger condition in respect of a crop record:
i. capturing a calculation date;
ii. determining the precipitation received (P_{R}) at the field site from the planting date to the calculation date, based on data stored within a current precipitation data source containing daily actual precipitation amounts for the field site for each calendar day of the current growing season;
iii. determining the forecast precipitation (P_{F}) at the field site from the calculation date to the completion date;
iv. calculating the total available moisture (M_{Total}) using the formula:
M_{Total}=((W_{Raw}−WP)+P_{R}+P_{F})−MF
v. calculating the yield potential (YP) using the formula:
YP=M_{Total}*F_{UE}
vi. creating a related yield potential record in the yield potential database, linked to the related crop record and storing the yield potential (YP) along with the other record contents.

30. The method of claim 29 wherein the trigger condition is a manual trigger initiated by a user of the computer.

31. The method of claim 29 wherein the trigger condition is the arrival of a predetermined periodic frequency at which a forecasting calculation is set to be triggered in respect of a crop record.

32. The method of claim 29 wherein the forecast precipitation (P_{F}) is calculated from the corresponding calendar date range from the calculation date to the completion date in the historical precipitation data source.

33. The method of claim 29 wherein forecast precipitation (P_{F}) is identified from future precipitation forecasts.

34. The method of claim 29 wherein the yield potential (YP) is calculated using the modified formula:
YP=M_{Total}*F_{UE}*_{Ag}
and further comprising, at the initiation of the trigger step, determining a subjective agronomic factor (F_{Ag}), having a default value of 1 and adjusted for any additional agronomic variables stored in the related crop record.

35. The method of claim 34 wherein the additional agronomic variables are selected from the group of:
a. field stresses for the field site;
b. soil test values for the field site;
c. planned fertilizer application rates for the field site;
d. the planned timing for fertilizer application within the current growing season;
e. details of planned chemical applications at the field site; and
f. specific growing characteristics of the selected crop.

36. The method of claim 34 wherein a user can modify the subjective agronomic factor (F_{Ag}) in respect of a crop record to revise the forecasting scenario executed.

37. The method of claim 29 further comprising establishing the crop water use efficiency factor for a crop record at the time of creation of the crop record, by:
a. using the computer to calculate or a user interface to capture:
i. the historical seasonal precipitation (P_{Hist}) from a planting date to a completion date of the current growing season, based on data stored within the historical precipitation data source;
ii. an initial moisture factor (MF) for the selected crop, being the required amount of available water for the selected crop to establish initial crop growth;
iii. a historical yield (Y_{Hist}) for the selected crop;
b. determining the crop water use efficiency factor (F_{UE}) using the formula:
$${F}_{UE} = \frac{{Y}_{Hist}}{{P}_{Hist} - MF}$$
c. storing the crop water use efficiency factor (F_{UE}) to the crop record for use in subsequent calculations.

38. The method of claim 29 wherein the moisture reading for a sample depth is determined using moisture measurement of a manually extracted soil sample.

39. The method of claim 29 wherein the moisture reading for a sample depth is captured using at least one in-ground moisture sensor.

40. The method of claim 39 wherein the inground moisture sensor is any third-party sensor capable of providing a moisture reading from at least one sample depth within the rooting depth of the field site and which provides a data stream readable by the computer via a network interface.

41. The method of claim 29 wherein the current precipitation data source comprises precipitation data from at least one precipitation sensor proximate to the field site.

42. The method of claim 29 further comprising a display step wherein the yield potential (YP) stored in at least one yield potential record is displayed via a user interface to a user.

43. The method of claim 42 wherein the user interface operatively connected to the computer includes a graphical interface allowing for the graphical display of the contents of multiple yield potential records pertaining to a particular selected crop in a field site within a growing season to a user, and a graph of the yield potential (YP) values from multiple yield potential records is displayed to a user.

44. A non-transitory computer-readable storage medium storing for use in a method of estimating yield potential (YP) within a current growing season for a selected crop planted at a field site, the computer-readable storage medium including instructions comprising a forecasting software component that when executed by a computer cause the computer to:
a. using a user interface or data stored in the memory of the computer, determine at least the following method parameters:
i. a planting date and a completion date defining the current growing season, and a calculation date being the effective date of the estimate calculation;
ii. the historical seasonal precipitation (P_{Hist}), being the total of daily average precipitation amounts for a calendar date range defined by the planting date to the completion date of the current growing season, based on data stored within a historical precipitation data source containing daily average precipitation amounts for the field site for each calendar day of at least one previous growing season;
iii. an initial moisture factor (MF) for the selected crop, being the required amount of available water for the selected crop to establish initial crop growth;
iv. a historical yield (Y_{Hist}) for the selected crop;
v. a permanent wilting point (WP) of the field site, being the inferior limit of crop available water in the soil of the field site; and
b. for the current growing season:
i. determining the raw soil water value (W_{Raw}) within a rooting depth of the field site at the planting date based on at least one moisture reading captured in relation to a sample depth within the rooting depth;
ii. determining the precipitation received (P_{R}) at the field site from the planting date to the calculation date, based on data stored within a current precipitation data source containing daily actual precipitation amounts for the field site for each calendar day of the current growing season;
iii. determining the forecast precipitation (P_{F}) at the field site from the calculation date to the completion date;
c. calculating a crop water use efficiency factor (F_{UE}) using the formula:
$${F}_{UE} = \frac{{Y}_{Hist}}{{P}_{Hist} - MF}$$
d. calculating the total available moisture (M_{Total}) using the formula:
M_{Total}=((W_{Raw}−WP)+P_{R}+P_{F})−MF
e. calculating the yield potential (YP) using the formula:
YP=M_{Total}*F_{UE}
f. storing the calculated yield potential (YP) in the memory of the computer.

45. The non-transitory computer-readable storage medium of claim 44 wherein:
a. the method parameters further include a subjective agronomic factor (F_{Ag}), having a default value of 1, adjusted for any additional agronomic variables which would alter crop water usage in the current growing season; and
b. the yield potential (YP) is calculated using the modified formula:
YP=M_{Total}*F_{UE}*F_{Ag}

46. The non-transitory computer-readable storage medium of claim 44 wherein the computer will also be caused to display the yield potential (YP) to a user of the computer.

47. The non-transitory computer-readable storage medium of claim 44 wherein the computer will also store the yield potential (YP) and other parameters and calculations related thereto to a yield potential record in a yield potential database accessible to the computer in respect of the selected crop, the field site and the calculation date.
